(19) United States
(12) Patent Application Publication
(10) Pub. No.: US 2024/0080868 A1
(43) Pub. Date: Mar. 7, 2024

(54) SIDELINK INTER-UE COORDINATION PROCEDURES

(71) Applicant: Fraunhofer-Gesellschaft zur Förderung der angewandten Forschung e.V., München (DE)

(72) Inventors: Sarun SELVANESAN, Berlin (DE); Baris GÖKTEPE, Berlin (DE); Thomas FEHRENBACH, Berlin (DE); Thomas WIRTH, Berlin (DE); Thomas SCHIERL, Berlin (DE); Cornelius HELLGE, Berlin (DE)

(21) Appl. No.: 18/505,380

(22) Filed: Nov. 9, 2023

Related U.S. Application Data
(63) Continuation of application No. PCT/EP2022/062506, filed on May 9, 2022.

(30) Foreign Application Priority Data
May 10, 2021 (EP) 21173155.9

(51) Int. Cl. H04W 72/40; H04L 5/00; H04W 28/26; H04W 72/25

(52) U.S. Cl. CPC H04W 72/40; H04L 5/0053; H04W 28/26; H04W 72/25

(57) ABSTRACT

A user device, UE, for a wireless communication system, is described. The UE may transmit and/or receive over a sidelink, SL, in the wireless communication system. Responsive to detecting one or more collisions on one or more resources used or reserved to be used by a further UE for one or more transmissions over the SL, the UE may transmit a collision indication, Cl, and an assistance information, like an assistance information message, AIM, the assistance information indicating one or more preferred and/or not preferred resources for a transmission by the further UE.

### CROSS-REFERENCES TO RELATED APPLICATIONS

This application is a continuation of copending International Application No. PCT/EP2022/062506, filed May 9, 2022, which is incorporated herein by reference in its entirety, and additionally claims priority from European Application No. EP 21 173 155.9, filed May 10, 2021, which is incorporated herein by reference in its entirety.

The present invention concerns the field of wireless communication systems or networks, more specifically the direct communication between user devices over a sidelink. Embodiments concern inter-UE coordination for improving a communication over the sidelink, e.g., for meeting an enhanced reliability and reduced latency requirements for a communication over the sidelink.

### BACKGROUND OF THE INVENTION

FIG. 1 is a schematic representation of an example of a terrestrial wireless network 100 including, as is shown in FIG. 1(a), the core network 102 and one or more radio access networks RAN₁, RAN₂, . . . RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114, to 1145, which are schematically represented in FIG. 1(b) by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116, to 116₅, which are schematically represented in FIG. 1(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st} stage SCI, and optionally, a second control region which contains a second part of control information, also referred to as the 2^{nd} stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

In mobile communication networks, for example in a network like that described above with reference to FIG. 1, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5/PC3 interface, one of the UEs may also be connected with a BS, and may relay information from the BS to the other UE via the sidelink interface and vice-versa. The relaying may be performed in the same frequency band, in-band-relay, or another frequency band, out-of-band relay, may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs in NR or mode 4 UEs in LTE are outside of the coverage 200 of a base station, rather, it means that the respective mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present. In addition, FIG. 3, schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210

Although FIG. 2 and FIG. 3 illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

In the above-described scenarios of vehicular user devices, UEs, a plurality of such user devices may form a user device group, also referred to simply as group, and the communication within the group or among the group members may be performed via the sidelink interfaces between the user devices, like the PC5 interface. For example, the above-described scenarios using vehicular user devices may be employed in the field of the transport industry in which a plurality of vehicles being equipped with vehicular user devices may be grouped together, for example, by a remote driving application. Other use cases in which a plurality of user devices may be grouped together for a sidelink communication among each other include, for example, factory automation and electrical power distribution. In the case of factory automation, a plurality of mobile or stationary machines within a factory may be equipped with user devices and grouped together for a sidelink communication, for example for controlling the operation of the machine, like a motion control of a robot. In the case of electrical power distribution, entities within the power distribution grid may be equipped with respective user devices which, within a certain area of the system may be grouped together so as to communicate via a sidelink communication with each other so as to allow for monitoring the system and for dealing with power distribution grid failures and outages.

In view of the above-described conventional technology, there may be a need for improvements of the communication over a sidelink in a wireless communication network between two user devices.

### SUMMARY

An embodiment may have a user device, UE, for a wireless communication system, wherein the UE is to transmit and/or receive over a sidelink, SL, in the wireless communication system, the SL comprising a SL feedback channel, like the PSFCH, for transmitting a SL feedback for a transmission over the SL using one or more first resources of the SL feedback channel associated with the transmission, wherein, responsive to detecting one or more collisions on one or more resources used or reserved to be used by a further UE for one or more transmissions over the SL, the UE is to signal a collision indication, Cl, wherein, for signaling the Cl, the UE is to
transmit a SL feedback for the transmission affected by the resource collision using one or more second resources of the SL feedback channel associated with the transmission affected by the resource collision, the first and second resources being different, or
transmit a SL feedback for the transmission affected by the resource collision using one or more resources of a further SL feedback channel before the transmission associated with the transmission affected by the resource collision, or
transmit a SL feedback for the transmission affected by the resource collision using one or more configured or preconfigured resources separate from the SL feedback channel, like resources of a collision indicator channel.

Another embodiment may have a user device, UE, for a wireless communication system, wherein the UE is to transmit and/or receive over a sidelink, SL in the wireless communication system, the SL comprising a SL feedback channel, like the PSFCH, for transmitting a SL feedback for a transmission over the SL using the one or more first resources of the SL feedback channel associated with the transmission, and wherein the UE is to receive from one or more further UEs a collision indication on
one or more second resources of the SL feedback channel associated with the transmission affected by the resource collision, the first and second resources being different, or
one or more resources of a further SL feedback channel before the transmission associated with the transmission affected by the resource collision, or
one or more configured or preconfigured resources separate from the SL feedback channel, like resources of a collision indicator channel.

Another embodiment may have a method for operating a user device, UE, for a wireless communication system wherein the UE is to transmit and/or receive over a sidelink, SL, in the wireless communication system, the SL comprising a SL feedback channel, like the PSFCH, for transmitting a SL feedback for a transmission over the SL using one or more first resources of the SL feedback channel associated with the transmission, the method comprising: detecting one or more collisions on one or more resources used or reserved to be used by a further UE for one or more transmissions over the SL, and signaling a collision indication, Cl, by
transmitting a SL feedback for the transmission affected by the resource collision using one or more second resources of the SL feedback channel associated with the transmission affected by the resource collision, the first and second resources being different, or
transmitting a SL feedback for the transmission affected by the resource collision using one or more resources of a further SL feedback channel before the transmission associated with the transmission affected by the resource collision, or
transmitting a SL feedback for the transmission affected by the resource collision using one or more configured or preconfigured resources separate from the SL feedback channel, like resources of a collision indicator channel.

### BRIEF DESCRIPTION OF THE DRAWINGS

Embodiments of the present invention will be detailed subsequently referring to the appended drawings, in which:

FIGS. 1(a)-1(b) show a schematic representation of an example of a wireless communication system;

FIG. 2 is a schematic representation of an in-coverage scenario in which two UEs directly communicating with each other are both connected to a base station;

FIG. 3 is a schematic representation of an out-of-coverage scenario in which the UEs directly communicate with each other;

FIG. 4 is a schematic representation of a wireless communication system including a transmitter, like a base station, and one or more receivers, like user devices or UEs, capable of operating in accordance with embodiments of the present invention;

FIG. 5 illustrates an embodiment of the first aspect of the present invention;

FIG. 6 illustrates embodiments of the first aspect of the present invention for transmitting a Cl and an AIM by a UE responsive to detecting a collision for a transmission;

FIG. 7 illustrates an embodiment of the second aspect of the present invention;

FIGS. 8(a)-8(d) illustrate further embodiments of the second aspect of the present invention, wherein FIG. 8(a) illustrates a conventional approach and FIG. 8(b) to FIG. 8(d) illustrate embodiments of the second aspect;

FIG. 9 illustrates embodiments of the second aspect of the present invention for signaling one or more Cl messages using the PSFCH or the Cl channel;

FIG. 10 illustrates embodiments of the second aspect of the present invention providing a minimum gap for a pre-collision indication;

FIG. 11 illustrates an embodiment of a Cl-triggered reservation cancellation putting an RX UE into an idle mode and shifting an DRX active window;

FIGS. 12(a)-12(c) illustrate an embodiment of a flow chart for the operation of a UE to decide on what type of AIM to send;

FIGS. 13(a)-13(c) illustrate an embodiment of a flow chart for the operation of a UE to identify a scenario when to send a collision indication;

FIGS. 14(a)-14(c) illustrate an embodiment of a flow chart for the operation of a UE to identify scenarios where it sends a collision indication and by an AIM; and

FIG. 15 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings in which the same or similar elements have the same reference signs assigned.

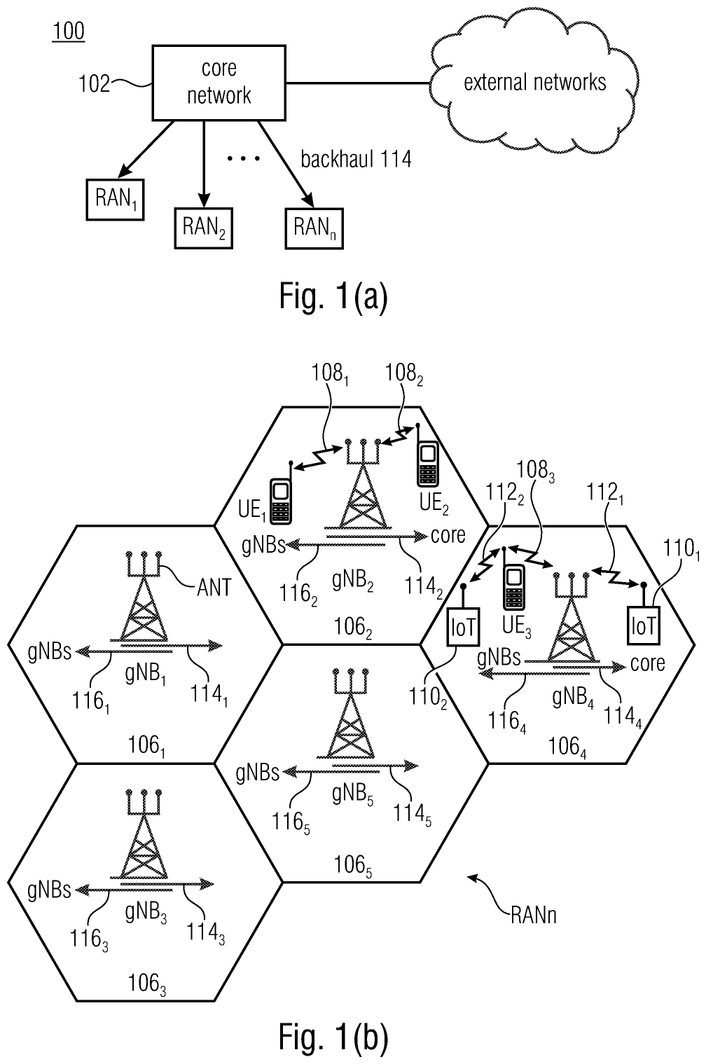

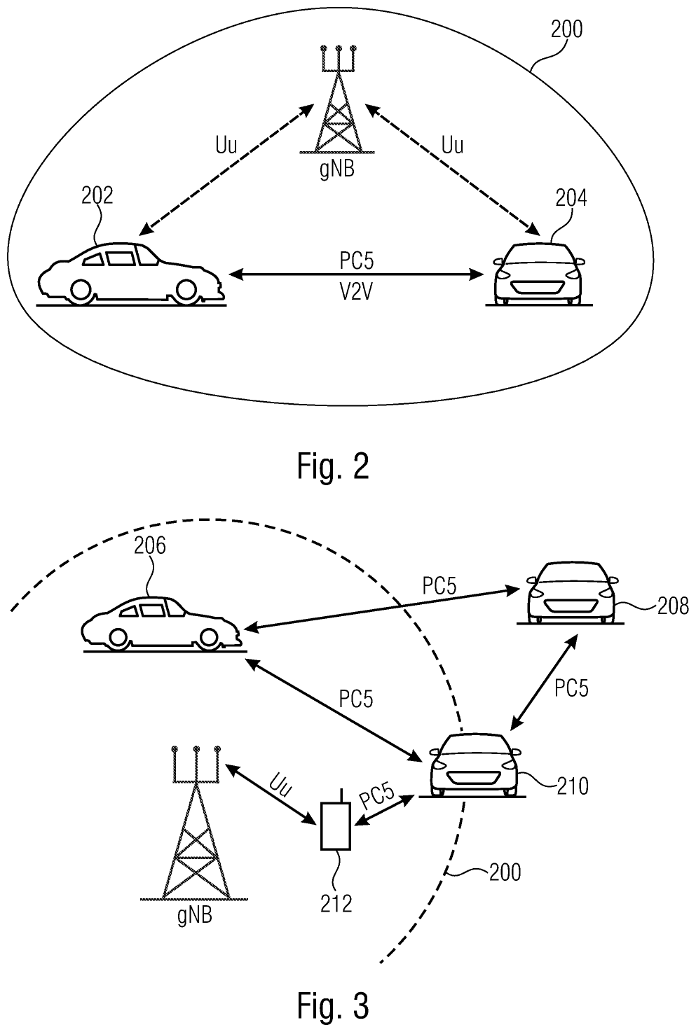

For a wireless communication system or network as described above with reference to FIG. 1, FIG. 2 or FIG. 3, an initial vehicle-to-everything, V2X, specification was included in Rel. 14 of the 3GPP standard on the basis of the original device-to-device, D2D, communication standard with modifications regarding the scheduling and assignment according to the V2X requirements. Rel. 15 of the LTE V2X standards, also known as enhanced V2X or eV2X, was completed in 2018, and Rel. 16, the first release of 5G NR V2X, was completed in March 2020. The new release focuses on sidelink enhancements with an emphasis on power saving, enhanced reliability and reduced latency to cater not only vehicular communications but also public safety and commercial use cases. In order to meet enhanced reliability and reduced latency requirements, inter-UE coordination among UEs communicating over the sidelink may be employed. Inter-UE coordination is essentially assistance provided by a UE-A to a UE-B. The assistance may be in the form of a set of resources that are determined by UE-A to be available or unavailable for use by UE-B, and a report including this information may be sent to UE-B. Another term for a set of available or unavailable resources are a set of preferred or not-preferred resources. UE-B, in turn, may use this report to decide about transmission resources to be used by UE-B. In accordance with other examples, inter-UE coordination may also be in the form of an indication of a collision in the future or in the past, which triggers the transmitting UE to carry out a resource re-selection. The inter-UE coordination may employ so-called assistance information messages, AIMs, or coordination information messages, CIMs, which may contain a list of available or unavailable resources to be considered by a UE-B or an indication of a collision. The AIMs may contain one or more of the following:
sensing results,
candidate resource sets,
a specific of resources based on the candidate resource set,
a set of specific resources, like time and frequency, or time slots where the UE providing the AIM is transmitting, to avoid the half-duplex issue, or where collisions are detected for a transmission in the past or for a transmission in the future, e.g., based on received control messages for the sidelink, like sidelink control information, SCIs.

Details of the AIMs are described, e.g., in the following European patent applications, the contents of which is incorporated herein by reference:
EP 20164706.2, “NR SIDELINK ASSISTANCE INFORMATION MESSAGES”, filed on Mar. 20, 2020
EP 20197035.7, “TIMING ASPECTS FOR NR SL ASSISTANCE INFORMATION MESSAGES”, filed on Sep. 18, 2020
EP 20203155.5, “NR SIDELLINK ASSISTANCE INFORMATION MESSAGES PROCEDURES”, filed on Oct. 21, 2020

In NR V2X, Mode 2 UEs are expected to carry out resource allocation autonomously. These UEs do not receive any assistance from the gNB, for example in the form of dynamic or configured grants, nor from any other source. Instead, they carry out sensing in order to determine available resources that may be used for their transmissions. Inter-UE coordination provides assistance information from one UE, like UE-A, to another UE, like UE-B, so that UE-B may use the assistance information when carrying out the resource selection. The AIM may contain information for assisting UE-B in its resource selection process. For example, an AIM may contain one or more of the following:
a list of all available resources, resource blocks or subchannels in a set of time slots, also referred to as preferred resources,
a list of all resources, resource blocks or subchannels that are unavailable in a set of time slots, also referred to as not preferred resources,
a list of resources, resource blocks or subchannels for which collisions are expected, for example a list of all reservations or of resources where there is a reservation and the UE-B is expected to transmit as well.

The resources contained within an AIM may be interpreted by UE-B as one of the following:
sensing results, i.e., a list of resources within a sensing window with their measured RSRP values included,
a candidate resource set, i.e., a set of resources that is within a selection window,
specific resources or a set of certain resources that are already selected from the candidate resource set and are ready to be used for the transmission,
specific resources or time slots or a set of certain resources when UE-A is transmitting, to avoid the half-duplex issue, or where collisions are detected in past/future based on received SCIs.

For a UE, like UE-A, to generate a preferred set of resources based on sensing results, the UE requires the following parameters, as per the Rel. 16 sensing process:
a sidelink Reference Signal Received Power, SL RSRP, threshold or SL priority,
a selection window or packet delay budget, PDB,
a number of subchannels,
a resource reservation interval,
a resource pool ID, e.g., of the resource pool including resources to be used for a SL communication.

UE-B may use a received AIM by combining the resources indicated in the AIM with its own full or limited sensing results, or by using only the resources indicated in the AIM for a transmission.

There are two conventional schemes for the inter-UE coordination. In accordance with scheme 1, an AIM is sent from UE-A to UE-B which contains, as mentioned above, a set of preferred or not preferred resources, which UE-B may, in turn, use for its own transmissions, more specifically for selecting the resources for its own transmissions. In accordance with scheme 2, an indication is sent from UE-A to UE-B of a resource collision that occurred either in the past or may happen in the future. In accordance with scheme 2, no resources sets are included in the indication that is sent to UE-B. UE-B is expected to trigger a resource reselection or to determine the necessity of one or more retransmissions based on the collision indication received. Conventionally, the indication informing UE-B about a resource collision is in the form on a non-acknowledgement, NACK, that is sent on the physical sidelink feedback channel, PSFCH, or on a channel provided for indications to be sent. Conventionally, scheme 2 is only used for groupcast option 1 in accordance with which only a NACK is sent in case of a failed transmission. This covers, primarily, scenarios where UE-B and UE-C are communicating with each other and transmit on the same time slot. Due to the half-duplex constraint, neither UE-B nor UE-C is able to listen to each other, however, UE-A may be able to receive the SCIs for both transmissions in the same time slot and identify the collision. Based on this identification or detection of the collision, UE-A may send a NACK on the PSFCH corresponding to the transmission of UE-B or UE-C so as to inform the respective UE about a failed transmission.

The drawback of scheme 2 is that it is restricted to groupcast option 1 transmissions and does not provide UE-B with any additional information regarding the resources that may be used for the retransmission of a failed transmission or failed packet. The present invention addresses the above drawbacks and presents approaches allowing scheme 2 to be adapted to all cast types and to provide information to a UE about the detected collision.

First Aspect

In accordance with a first aspect, the above-described schemes 1 and 2 are combined into a new scheme 3. In accordance with the first aspect, a UE, like UE-A, sends a collision indication together with an AIM. Stated differently, responsive to detecting a collision, UE-A sends not only the collision indication, e.g., in accordance with scheme 1, but also assistance information, e.g., an AIM in accordance with scheme 2. This aspect is advantageous as it addresses the issue of the UE receiving the collision indicator, like UE-B, not having enough information for re-selecting resources after being informed of a potential or past collision.

Second Aspect

In accordance with a second aspect of the present invention, instead of using the above-described NACK as a collision indication in scheme 2, an alternative collision indication is introduced for enabling UE-B to receive the indication about the collision irrespective of the cast type associated with the transmission, thereby overcoming the limitations in scheme 2, namely the limitation to the groupcast option 1 transmissions as well as the ambiguity between a conventional NACK and a NACK indicating a collision.

Third Aspect

In accordance with a third aspect of the present invention, approaches are provided as to what type of AIM and/or collision indication UE-A sends, dependent on a scenario where UE-A detected a potential or past collision, like a collision associated with a transmission to be performed by UE-B or a collision associated with a transmission already performed by the UE-B. The third aspect takes into account the action by UE-A for each of the conventional schemes 1 and 2 and for the new scheme 3. Embodiments of the third aspect concern an approach for deciding by UE-A which of the schemes 1, 2 and 3 is to be used, based on the set of predefined criteria.

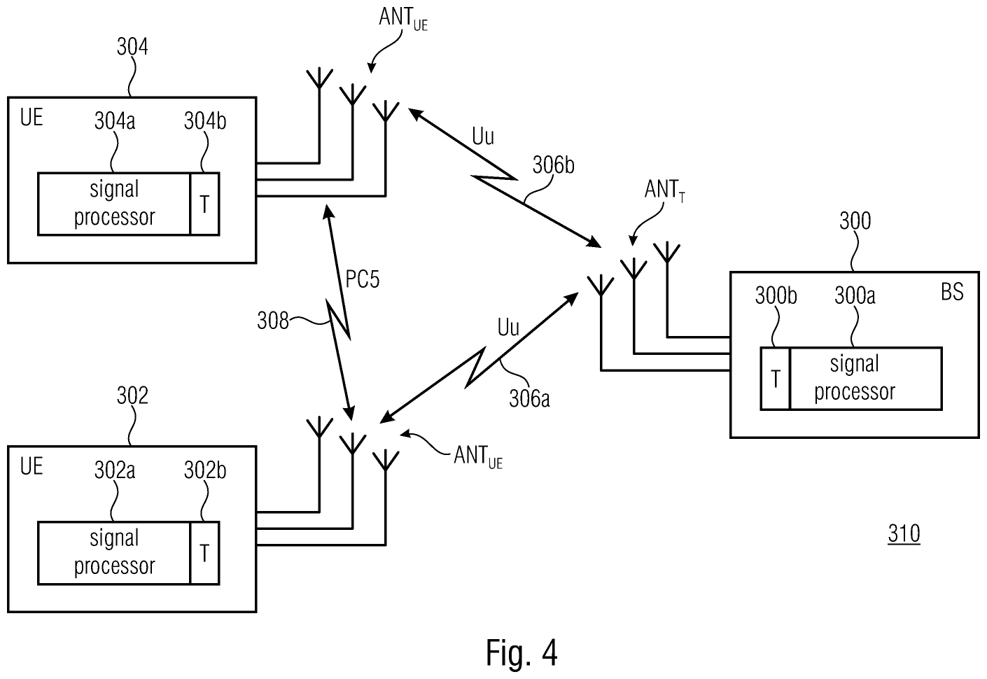

Embodiments of the present invention may be implemented in a wireless communication system as depicted in FIG. 1, FIG. 2 or FIG. 3 including base stations and users, like mobile terminals or IoT devices. FIG. 4 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 4, the one or more UEs 302, 304 of FIG. 4, and the base station 300 of FIG. 4 may operate in accordance with the inventive teachings described herein.

First Aspect

The present invention provides a user device, UE, for a wireless communication system,
wherein the UE is to transmit and/or receive over a sidelink, SL, in the wireless communication system, and
wherein, responsive to detecting one or more collisions on one or more resources used or reserved to be used by a further UE for one or more transmissions over the SL, the UE is to transmit a collision indication, Cl, and an assistance information, like an assistance information message, AIM, the assistance information indicating one or more preferred and/or not preferred resources for a transmission by the further UE.

In accordance with embodiments, the UE is to transmit the Cl and the assistance information such that:
in the time domain,
   the assistance information and the Cl are transmitted at the same time, or
   the assistance information follows the Cl immediately or with a time gap therebetween, or
   the Cl follows the assistance information immediately or with a time gap therebetween,
in the frequency domain,
   the assistance information and the Cl are transmitted at the same frequencies, or
   the assistance information and the Cl are transmitted at different continuous or separated frequencies.
In accordance with embodiments, the time gap is configured or preconfigured, for example per resource pool or system wide or for a specific network slice, like a Ultra Reliable Low Latency Communication, URLLC, slice, or for a certain UE capability, like for a Pedestrian UE, P-UE, only, or for a certain Discontinuous Reception, DRX, pattern.
In accordance with embodiments, the one or more preferred and/or not preferred resources are to be used for one or more further transmissions by the further UE or for one or more retransmissions by the further UE for a transmission affected by the detected resource collision.
In accordance with embodiments, the UE is to detect a collision on a resource using one or more received control messages for a transmission performed by the further UE and/or one or more received control messages for a transmission not performed by the further UE.
In accordance with embodiments, the UE is to detect a collision on a resource associated with a past transmission already performed by the further UE and/or a future transmission reserved or indicated to be performed by the further UE.
In accordance with embodiments, the one or more preferred resources comprise resources available for the further UE for a transmission instead of the one or more resources for which a resource collision was detected, and wherein the one or more not preferred resources comprise resources the further UE is to avoid for a transmission or retransmission.
In accordance with embodiments, the UE is to determine the one or more preferred resources using configured or preconfigured sensing parameters and/or using sensing parameters derived from information included in one or more control messages, like Sidelink Control Information, SCI, for a transmission for which a resource collision was detected.
In accordance with embodiments, the information included in a control message and used for deriving the sensing parameters comprise one or more of the following:
a priority associated with the transmission indicated in the control message,
a resource reservation period indicated in the control message,
a number of sub-channels associated with the transmission indicated in the control message e.g., a frequency resource indicator value, FRIV, format,
the resources reserved within a certain number of future time slots using, e.g., a time resource indicator value, TRIV, format,
the resource pool in which the control message was received,
   one or more Hybrid Acknowledge Request, HARQ, parameters,
geo-location, e.g., a zone-ID derived from the SCI for allowing another UE which is in close vicinity to the UE to perform partial sensing or full sensing.

In accordance with embodiments, the sensing parameters comprise a remaining Packet Delay Budget, PDB, associated with a packet being transmitted by the further UE₁ and wherein the UE is to
estimate the remaining PDB from the resources reserved for the transmission within a certain number of future time slots using, e.g., a time resource indicator value, TRIV, format, included in the control message, like the SCI, for the transmission for which the resource collision was detected, and/or
use a configured or preconfigured PDB depending on the transmission priority, source, or destination ID, and/or
use a configured or preconfigured PDB.

In accordance with embodiments, the assistance information includes a configured or preconfigured number m of the preferred resources, e.g., the top-m resources corresponding to different priority values, wherein the number m of resources included in the assistance information may decrease with a decrease of a priority associated with the resources.

In accordance with embodiments, the one or more not preferred resources comprise one or more of the following:
one or more resources or time slots when the UE is transmitting,
one or more resources or time slots where resource collisions are detected based on received control messages, like SCIs,
the worst-m resources, wherein the number m of resources included in the assistance information may decrease with a decrease of a priority associated with the resources.

In accordance with embodiments, the transmission of the further UE is directed to at least one receiving UE₁ and wherein the UE is the receiving UE or is not the receiving UE.

In accordance with embodiments, the collision indication comprises a non-acknowledgement, NACK, message, and wherein the UE is to transmit the NACK message on a predefined channel, like the Physical Sideling Feedback CHannel, PSFCH, or on a channel for sending a collision indication message, Cl.

In accordance with embodiments, the UE is to transmit the assistance information on the same channel on which the Cl is transmitted or on a channel, like the PSSCH, that is different from the channel on which the Cl is transmitted.

In accordance with embodiments,
the UE is to transmit the collision indication on resources of a SL feedback channel, like the PSFCH, that are different from resources on which a conventional SL feedback message is transmitted, or on configured or preconfigured resources separate from the SL feedback channel, like resources of a collision indicator channel, and
the collision indication comprises a conventional SL feedback message or a collision indication message, the collision indication message being different from the conventional SL feedback message.

In accordance with embodiments, the UE is to send the Cl using different cast-types dependent on the UEs affected by the resource collision, such as a broadcast to all other UEs in reach of the UE or groupcast to a subset of other UEs in reach of the UE or a unicast to a specific UE in reach of the UE, e.g., the UE from which the UE is to expect a retransmission or one or more further transmissions.

The present invention provides a user device, UE, for a wireless communication system,
wherein the UE is to transmit and/or receive over a sidelink, SL, in the wireless communication system, and
wherein the UE is to receive from one or more further UEs a collision indication, Cl, and assistance information, like an assistance information message, AIM, the collision indication indicating one or more collisions on one or more resources used or reserved to be used by the UE for one or more transmissions over the SL, and the assistance information indicating one or more preferred and/or not preferred resources for the transmission by the UE.

In accordance with embodiments, the assistance information and the Cl are received with a time gap therebetween.

In accordance with embodiments, the time gap is configured or preconfigured, for example per resource pool or system wide or for a specific network slice, like a Ultra Reliable Low Latency Communication, URLLC, slice, or for a certain UE capability, like for a Pedestrian UE, P-UE, only, or for a certain Discontinuous Reception, DRX, pattern.

In accordance with embodiments, responsive to the collision indication, the UE is to perform at least one of the following:
sense one or more resources for a transmission over the sidelink, and select, using the assistance information, resources for the transmission from the sensed resources, so as to avoid resources associated with a collision,
use preferred resources indicated in the assistance information as resources for the transmission without performing a sensing operation,
reselect resources for a retransmission without using the assistance information,
reselect resources for a retransmission, and crosscheck with resources from the assistance information,
determine a candidate resource set or a set of resources from the candidate resource set, and combine the candidate resource set or the set of resources with one or more or all resources in the assistance information, e.g., by including or excluding resources dependent on the content of the assistance information,
not carry out sensing at all, stop any further retransmissions that were identified to cause potential resource collisions by the Cl, and wait for the assistance information to provide a set of resources to use, or
perform DRX, e.g., for a configured back-off,
perform a random back-off, e.g., similar to a WiFI behavior,
a handover to a base station, like a gNB,
change to another resource pool,
transmit in an exceptional pool,
switch from mode1 to mode2, or vice versa.

Second Aspect

The present invention providers a user device, UE, for a wireless communication system,
wherein the UE is to transmit and/or receive over a sidelink, SL, in the wireless communication system, the SL including a SL feedback channel, like the PSFCH, for transmitting a SL feedback for a transmission over the SL using one or more first resources of the SL feedback channel associated with the transmission,
wherein, responsive to detecting one or more collisions on one or more resources used or reserved to be used by a further UE for one or more transmissions over the SL, the UE is to signal a collision indication, Cl,
wherein, for signaling the Cl, the UE is to
   transmit a SL feedback for the transmission affected by the resource collision using one or more second resources of the SL feedback channel associated with the transmission affected by the resource collision, the first and second resources being different, or
   transmit a SL feedback for the transmission affected by the resource collision using one or more resources of a further SL feedback channel before the transmission associated with the transmission affected by the resource collision, or
   transmit a SL feedback for the transmission affected by the resource collision using one or more configured or preconfigured resources separate from the SL feedback channel, like resources of a collision indicator channel.

In accordance with embodiments, for signaling the resource collision, the UE is to transmit a SL feedback for the transmission affected by the resource collision using one second resource of the SL feedback channel, the SL feedback including
a single collision indication, Cl, message by transmitting on the second resource one of a first SL feedback message, like an acknowledgement, ACK, or a second SL feedback message, like a non-acknowledgement, NACK, or
a first Cl message by transmitting on the second resource a first SL feedback message, like an acknowledgement, ACK, or a second Cl message by transmitting on the second resource a second SL feedback message, like a non-acknowledgement, NACK, or
a first Cl message by transmitting on the second resource a first SL feedback message, like an acknowledgement, ACK, or a second Cl message by transmitting on the second resource a second SL feedback message, like a non-acknowledgement, NACK, or a third Cl message by transmitting the first and second SL feedback messages on the first and second resources.

In accordance with embodiments, for signaling the resource collision, the UE is to transmit a SL feedback for the transmission affected by the resource collision using two second resources of the SL feedback channel, the SL feedback including
a first Cl message by transmitting the first SL feedback message, like an acknowledgement, ACK, or a second Cl message by transmitting the second SL feedback message, like a non-acknowledgement, NACK, on the first of the two further resources, and
a third Cl message by transmitting the first SL feedback message, like an acknowledgement, ACK, or a fourth Cl message by transmitting the second SL feedback message, like a non-acknowledgement, NACK, on the second of the two further resources.

In accordance with embodiments, for signaling the resource collision, the UE is to transmit a SL feedback for the transmission affected by the resource collision using n second resources of the SL feedback channel, n>1, the SL feedback including
n Cl messages, each Cl message being represented by transmitting the first SL feedback message, like an acknowledgement, ACK, or by transmitting the second SL feedback message, like a non-acknowledgement, NACK, on the n^{th} resource.

In accordance with embodiments, for signaling the resource collision, the UE is to transmit a SL feedback for the transmission affected by the resource collision using k messages of a collision indication channel resource, k>1, the SL feedback including
for k=1, a single collision indication, Cl, message by transmitting a first signal on the collision indication channel resource, or
for k>1, k Cl messages, each Cl message being represented by a cyclic shifted signal on the collision indication channel resource, wherein the cyclic shifts are different for the k Cl messages.

In accordance with embodiments, a Cl message indicates one or a combination of following messages:
an ACK,
a NACK,
any collision,
a past resource collision
a future resource collision
a certain location of a resource collision.

In accordance with embodiments, a Cl message indicates that the Cl and assistance information like an assistance information message, AIM, are transmitted, and

wherein the UE is to transmit the Cl and the assistance information such that:
in the time domain,
   the assistance information and the Cl are transmitted at the same time, or
   the assistance information follows the Cl immediately or with a time gap therebetween, or
   the Cl follows the assistance information immediately or with a time gap therebetween,
in the frequency domain,
   the assistance information and the Cl are transmitted at the same frequencies, or
   the assistance information and the Cl are transmitted at different continuous or separated frequencies.

In accordance with embodiments, the time gap is configured or preconfigured, for example per resource pool or system wide or for a specific network slice, like a Ultra Reliable Low Latency Communication, URLLC, slice, or for a certain UE capability, like for a Pedestrian UE, P-UE, only, or for a certain Discontinuous Reception, DRX, pattern.

In accordance with embodiments, the UE is to determine an index of the one or more second resources of the feedback channel according to

(P_{ID}+M_{ID})mod R,o

(P_{ID}+C_{ID})mod R, or

(P_{ID}+C_{ID}+M_{ID})mod R, or

(P_{ID}+M_{ID})mod 2R

where R is the number feedback or collision indication channel resources, P_{ID} is a source ID indicated, e.g., by 2^{nd} stage SCI associated with the transmission, M_{ID} has a values different from the value used for signalling a SL feedback, e.g., M_{ID} is set to a preconfigured or configured value or is signalled, e.g., in the 2^{nd} stage SCI, or is a destination ID for P_{ID}, C_{ID} is a preconfigured or configured value or is a value signaled, e.g., in the 2^{nd} stage SCI, or is a value signaled by higher layers.

In accordance with embodiments, in case the UE detects a resource collision associated with a future transmission to be performed by the further UE, the UE is to transmit the collision indication such that there is a minimum gap between a slot in which the collision indication is transmitted and a resource associated with the collision.
In accordance with embodiments, the minimum gap indicates
in which slot the collision indication is to be transmitted, or
a minimum time gap allowing the UE to determine the latest slot containing a PSFCH channel or a further SL feedback channel or a collision indication channel fulfilling the minimum gap, e.g., a latest slot containing a PSFCH or a further SL feedback channel or a Cl channel at least the minimum gap ahead of the resource associated with the collision.

In accordance with embodiments, the minimum gap is
preconfigured or configured, for example by a Radio Resource Control, RRC, signaling or by a System Information Block, SIB, or by a Master Information Block, MIB, e.g., as part of a resource pool configuration, or
indicated in a SL control message, like a SCI, or
configured during the synchronization step between the two UEs.

In accordance with embodiments,
the UE is to operate in a Discontinuous Reception, DRX, mode,
the UE is the intended recipient for a transmission by the further UEs during an ON duration and one or more future transmissions after the ON duration,
responsive to transmitting the collision indication or the assistance information associated with a future transmission,
the UE is to not extend the ON duration and enter a sleep mode until the further UE completed the sensing and resource reselection process, or
the UE is to not extend the ON duration and adapt the DRX cycle such that the ON duration occurs once the further UE completed the sensing or partial sensing and resource reselection process.

In accordance with embodiments, when entering the sleep mode, the UE is to start a collision indication timer, and, once the collision indication timer lapsed, the UE is to return to an active mode.

In accordance with embodiments, the collision indication timer is configured or preconfigured, for example per resource pool or system wide or for a specific network slice, like a Ultra Reliable Low Latency Communication, URLLC, slice, or for a certain UE capability, like for a Pedestrian UE, P-UE, only, or for a certain Discontinuous Reception, DRX, pattern.

In accordance with embodiments, the UE is to adapt the DRX cycle in case a probability associated with the resource collision is above a preconfigured or configured threshold.

In accordance with embodiments,
in case the UE is the intended recipient for the transmission by the further UEs, the UE is to transmit a first collision indication, and
in case the UE is not the intended recipient for the transmission by the further UEs, the UE is to transmit a second collision indication, the first and second collision indications being different.

The present invention provides a user device, UE, for a wireless communication system,
wherein the UE is to transmit and/or receive over a sidelink, SL in the wireless communication system, the SL including a SL feedback channel, like the PSFCH, for transmitting a SL feedback for a transmission over the SL using the one or more first resources of the SL feedback channel associated with the transmission, and wherein the UE is to receive from one or more further UEs a collision indication on
one or more second resources of the SL feedback channel associated with the transmission affected by the resource collision, the first and second resources being different, or
one or more resources of a further SL feedback channel before the transmission associated with the transmission affected by the resource collision, or
one or more configured or preconfigured resources separate from the SL feedback channel, like resources of a collision indicator channel.

In accordance with embodiments, the collision indication indicates to the further UE:
one or more resources on which the collision is to occur in the future or already occurred in the past, or
that a collision was detected, e.g., in the future or in the past, and that the UE is to expect receiving assistance information, the assistance information indicating one or more preferred and/or not preferred resources for a transmission, or
one or more resources on which the collision is to occur in the future or already occurred in the past and that the UE is to expect receiving UE assistance information, the assistance information indicating one or more preferred and/or not preferred resources for a transmission.

In accordance with embodiments, responsive to the collision indication, the UE is to perform at least one of the following
sense one or more resources for a transmission over the sidelink, and select, using the assistance information, resources for the transmission from the sensed resources, so as to avoid resources associated with a collision,
use preferred resources indicated in the assistance information as resources for the transmission without performing a sensing operation,
reselect resources for a retransmission without using the assistance information,
reselect resources for a retransmission, and crosscheck with resources from the assistance information,
determine a candidate resource set or a set of resources from the candidate resource set, and combine the candidate resource set or the set of resources with one or more or all resources in the assistance information, e.g., by including or excluding resources dependent on the content of the assistance information,
not carry out sensing at all, stop any further retransmissions that were identified to cause potential resource collisions by the Cl, and wait for the assistance information to provide a set of resources to use, or
perform DRX, e.g., for a configured back-off,
perform a random back-off, e.g., similar to a WiFI behavior,
a handover to a base station, like a gNB,
change to another resource pool,
transmit in an exceptional pool,
switch from mode1 to mode2, or vice versa.

Third Aspect

The present invention provides a user device, UE, for a wireless communication system,
wherein the UE is to transmit and/or receive over a sidelink, SL, in the wireless communication system, and
wherein, responsive to a request from a further UE or responsive to a certain event, the UE is to transmit to the further UE assistance information, like an assistance information message, AIM, indicating one or more preferred and/or not preferred resources for a transmission by the further UE.

In accordance with embodiments, responsive to a request from the further UE that includes relevant sensing or partial sensing parameters for generating the one or more preferred resources or that includes a configuration list containing information regarding the sending and generation of the assistance information, e.g., a priority, a destination ID, a cast type of the transmission, and/or a periodicity for transmitting the assistance message, the UE is to generate
as preferred resources for a transmission by the further UE
   a candidate resource set, or
   a specific set of resources for transmission based on a candidate resource set, and/or
as non-preferred resources for a transmission by the further UE
   one or more time slots when the UE is transmitting, and/or
   one or more time slots where, based on received SCIs, the UE detects one or more resource collisions associated with a past transmission or with a future transmission, and/or
   the worst-m resources, wherein the number m of resources included in the assistance information may decrease with a decrease of a priority associated with the resources.

In accordance with embodiments, responsive to a request from the further UE that includes a subset of relevant sensing or partial sensing parameters for generating the one or more preferred resources, the UE is to generate
as preferred resources for a transmission by the further UE
   a candidate resource set, or
as non-preferred resources for a transmission by the further UE
   one or more time slots when the UE is transmitting, and/or
   one or more time slots where, based on received SCIs, the UE detects one or more resource collisions associated with a past transmission or with a future transmission, and/or
   the worst-m resources, wherein the number m of resources included in the assistance information may decrease with a decrease of a priority associated with the resources.

In accordance with embodiments, responsive to a request from the further UE that includes no sensing or partial sensing parameters for generating the one or more preferred resources, the UE is to generate
in case the UE is capable to derive sensing parameters from one or more previous transmissions, as preferred resources for a transmission by the further UE
   a candidate resource set, or
   a specific set of resources for transmission based on a candidate resource set, and/or
as non-preferred resources for a transmission by the further UE
   one or more time slots when UE is transmitting, and/or
   one or more time slots where, based on received SCIs, the UE detects one or more resource collisions associated with a past transmission or with a future transmission, and/or
   the worst-m resources, in case the UE is capable to derive sensing or partial sensing parameters from one or more previous transmissions, wherein the number m of resources included in the assistance information may decrease with a decrease of a priority associated with the resources.

In accordance with embodiments, responsive to detecting, based on received control messages, like SCIs, a collision on a resource associated with a past transmission already performed by the further UE and/or a future transmission to be performed by the further UE, the UE is to generate
based on the received control messages, as preferred resources for a transmission by the further UE
   a candidate resource set, or
   a specific set of resources for transmission based on a candidate resource set, and/or
as non-preferred resources for a transmission by the further UE
   one or more time slots where, based on received SCIs, the UE detects one or more resource collisions associated with a past transmission or with a future transmission, and/or
   the worst-m resources, based on the received control messages, wherein the number m of resources included in the assistance information may decrease with a decrease of a priority associated with the resources.

In accordance with embodiments, responsive to detecting, based on control messages, like SCIs, received from the further UE and time slots reserved for a transmission by the UE, a collision on a resource associated with a future transmission to be performed by the further UE, when the UE is the intended receiver UE for the transmission from the further UE, the UE is to generate
based on the received control messages, as preferred resources for a transmission by the further UE
   a candidate resource set, or
   a specific set of resources for transmission based on a candidate resource set, and/or
as non-preferred resources for a transmission by the further UE
   one or more time slots when UE is transmitting, and/or
   one or more time slots where, based on received SCIs, the UE detects one or more resource collisions associated with a past transmission or with a future transmission, and/or
   the worst-m resources, based on the received control messages, wherein the number m of resources included in the assistance information may decrease with a decrease of a priority associated with the resources.

In accordance with embodiments, responsive to a predefined resource pool congestion status, the UE is to generate
in case the UE is capable to derive sensing or partial sensing parameters from one or more previous transmissions, as preferred resources for a transmission by the further UE
   a candidate resource set, or
   a specific set of resources for transmission based on a candidate resource set, and/or
as non-preferred resources for a transmission by the further UE
   one or more time slots when UE is transmitting, and/or
   one or more time slots where, based on received SCIs, the UE detects one or more resource collisions associated with a past transmission or with a future transmission, and/or
   the worst-m resources, in case the UE is capable to derive sensing or partial sensing parameters from one or more previous transmissions, wherein the number m of resources included in the assistance information may decrease with a decrease of a priority associated with the resources.

The present invention provides a user device, UE, for a wireless communication system,
wherein the UE is to transmit and/or receive over a sidelink, SL, in the wireless communication system,
wherein the UE is to detect a collision on a resource used or reserved to be used by a further UE for a transmission over the SL, dependent on one or more certain criteria, the one or more certain criteria depending on whether the UE is an intended receiver of the transmission or not and/or on whether the collision is on a resource associated with a past transmission already performed by the further UE and/or a future transmission to be performed by the further UE₁ and
wherein, responsive to detecting a resource collision, the UE is to transmit a collision indication.

In accordance with embodiments, the UE is to transmit assistance information, like an assistance information message, the assistance information indicating one or more preferred or not preferred resources for a transmission by the further UE.
In accordance with embodiments, in case the UE is the intended receiver of the transmission and the collision is on a resource associated with a future transmission to be performed by the further UE, the UE is to transmit a collision indication when detecting, based on a control message, like a SCI, transmitted by the further UE, a future transmission in a time slot where:
the UE is transmitting to the further UE or to another UE, resulting in a half-duplex scenario where the UE is not capable to listen to the future transmission of the further UE, UE-B, and/or
the UE is receiving from another UE in the same time slot and in the same frequency resource as indicated for the future transmission of the further UE.

In accordance with embodiments, following the transmitting of the collision indication, the UE is to transmit assistance information, the assistance comprising:
based on the received control messages, as preferred resources for a transmission by the further UE
   a candidate resource set, or
   a specific set of resources for transmission based on a candidate resource set, and/or
as non-preferred resources for a transmission by the further UE
   one or more time slots when UE is transmitting, and/or
   one or more time slots where, based on received SCIs, the UE detects one or more resource collisions associated with the future transmission, and/or
   the worst-m resources, based on the received control messages, wherein the number m of resources included in the assistance information may decrease with a decrease of a priority associated with the resources.

In accordance with embodiments, in case the UE is the intended receiver of the transmission and the collision is on a resource associated with a past transmission already performed by the further UE, the UE is to transmit a collision indication when detecting, based on a control message, like a SCI, transmitted by the further UE for an initial transmission, a resource collision for one or more of retransmission time slots in the future.

In accordance with embodiments, following the transmitting of the collision indication, the UE is to transmit assistance information, the assistance comprising:
based on the received control messages, as preferred resources for a transmission by the further UE
   a candidate resource set, or
   a specific set of resources for transmission based on a candidate resource set, and/or
as non-preferred resources for a transmission by the further UE
   one or more time slots when UE is transmitting, and/or
   one or more time slots where, based on a SCI received for the initial transmission, the UE detects one or more resource collisions associated with a future transmission, and/or
the worst-m resources, based on the received control messages, wherein the number m of resources included in the assistance information may decrease with a decrease of a priority associated with the resources.

In accordance with embodiments, in case the UE is not the intended receiver of the transmission and the collision is on a resource associated with a future transmission to be performed by the further UE, the UE is to transmit a collision indication when detecting, based on a control message, like a SCI, transmitted by the further UE and by another UE, that:
the further UE addressed the transmission to the other UE₁ and the further UE and the other UE reserved the same time slot, causing both the further UE and the other UE to not receive each other's transmissions due to the half-duplex constraint, and/or
the further UE and the other UE reserved the same resource in time and/or frequency, which will cause a resource collision.

In accordance with embodiments, following the transmitting of the collision indication, the UE is to transmit assistance information, the assistance comprising:
based on the received control messages, as preferred resources for a transmission by the further UE
   a candidate resource set, or
   a specific set of resources for transmission based on a candidate resource set, and/or
as non-preferred resources for a transmission by the further UE
   one or more time slots where, based on received SCIs, the UE detects one or more resource collisions associated with the future transmission, and/or
   the worst-m resources, based on the received control messages, wherein the number m of resources included in the assistance information may decrease with a decrease of a priority associated with the resources.

In accordance with embodiments, in case the UE is not the intended receiver of the transmission and the collision is on a resource associated with a past transmission already performed by the further UE, the UE is to transmit a collision indication when detecting, based on a control message, like a SCI, transmitted by the further UE and by another UE, that:
the further UE and the other UE transmitted on the same time slot, causing both the further UE and the other UE to not receive each other's transmissions due to the half-duplex constraint, and/or
the further UE and the other UE transmitted on the same resource in time and/or frequency, which caused a resource collision.

In accordance with embodiments, following the transmitting of the collision indication, the UE is to transmit assistance information, the assistance comprising:
based on the received control messages, as preferred resources for a transmission by the further UE
   a candidate resource set, or
   a specific set of resources for transmission based on a candidate resource set, and/or
as non-preferred resources for a transmission by the further UE
   one or more time slots where, based on a SCI received for an initial transmission, the UE detects one or more resource collisions associated with a future transmission, and/or
   the worst-m resources, based on the received control messages, wherein
the number m of resources included in the assistance information may decrease with a decrease of a priority associated with the resources.

In accordance with embodiments, the UE is to send an AIM and/or a Cl is based on one or more of the following criteria:
a channel busy ratio or a channel occupancy,
a type of resource collision, like a collision associated with a past transmission or a collision associated with a future transmission,
a priority of the transmission,
a time resource indicator value, TRIV,
on a destination ID,
a cast type,
a source ID,
a resource pool, RP,
resource usage within a resource pool, e.g., start sending CIs, if the number of UEs transmitting in the same band is above a (pre-)configured threshold,
a transmission type, like HARQ transmission or blind repetitions,
a channel state information, CSI,
a Reference Signal Received Power, RSRP, or a Reference Signal Received Quality, RSRQ, or a range parameter,
a bandwidth of the detected resource collision,
a network configuration,
available sensing results,
an operating mode,
a power status or power saving mode.

In accordance with embodiments, the UE is to determine the one or more preferred resources using configured or preconfigured sensing parameters and/or using sensing parameters derived from information included in one or more control messages, like Sidelink Control Information, SCI, for a transmission for which a resource collision was detected.

In accordance with embodiments, the information included in a control message and used for deriving the sensing parameters comprise one or more of the following:
a priority associated with the transmission indicated in the control message,
a resource reservation period indicated in the control message,
a number of sub-channels associated with the transmission indicated in the control message e.g., a frequency resource indicator value, FRIV, format,
the resources reserved within a certain number of future time slots using, e.g., a time resource indicator value, TRIV, format,
the resource pool in which the control message was received,
one or more Hybrid Acknowledge Request, HARQ, parameters,
geo-location, e.g., a zone-ID derived from the SCI for allowing another UE which is in close vicinity to the UE to perform partial sensing or full sensing.

In accordance with embodiments, the sensing parameters comprise a remaining Packet Delay Budget, PDB, associated with a packet being transmitted by the further UE₁ and wherein the UE is to
estimate the remaining PDB from the resources reserved for the transmission within a certain number of future time slots using, e.g., a time resource indicator value, TRIV, format, included in the control message, like the SCI, for the transmission for which the resource collision was detected, and/or
use a configured or preconfigured PDB depending on the transmission priority, source, or destination ID, and/or
use a configured or preconfigured PDB.

General

In accordance with embodiments, the UE is operated in an out-of-coverage mode in which the UE
is not connected to a base station of the wireless communication system, e.g., the UE operates in Mode 2 or is not in an RRC connected state, so that the UE does not receive from the base station a sidelink resource allocation configuration or assistance, and/or
is connected to a base station of the wireless communication system, which, for one or more reasons, is not capable to provide a sidelink resource allocation configuration or assistance for the UE, and/or
is connected to a base station of the wireless communication system not supporting a sidelink service, like a NR V2X service, e.g., a GSM, UMTS or LTE base station.

In accordance with embodiments, the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a vehicular UE, or a vehicular group leader UE, GL-UE, or an IoT or narrowband IoT, NB-IoT, device, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

System

The present invention provides a wireless communication system, comprising a plurality of the inventive user devices, UEs, configured for a sidelink communication using, for example resources from a set of sidelink resources of the wireless communication system.

In accordance with embodiments, the wireless communication system comprises one or more base stations, wherein the base station comprises one or more of a macro cell base station, or a small cell base station, or a central unit of a base station, or a distributed unit of a base station, or an Integrated Access and Backhaul, IAB, node, or a road side unit, RSU, or a UE, or a group leader UE, GL-UE, or a relay or a remote radio head, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

Methods

The present invention provides a method for operating a user device, UE, for a wireless communication system, wherein the UE is to transmit and/or receive over a sidelink, SL, in the wireless communication system, the method comprising:
detecting one or more collisions on one or more resources used or reserved to be used by a further UE for one or more transmissions over the SL, and
transmitting a collision indication, Cl, and an assistance information, like an assistance information message, AIM, the assistance information indicating one or more preferred and/or not preferred resources for a transmission by the further UE.

The present invention provides a method for operating a user device, UE, for a wireless communication system, wherein the UE is to transmit and/or receive over a sidelink, SL, in the wireless communication system, the method comprising:
receiving from one or more further UEs a collision indication, Cl, and assistance information, like an assistance information message, AIM, the collision indication indicating one or more collisions on one or more resources used or reserved to be used by the UE for one or more transmissions over the SL, and the assistance information indicating one or more preferred and/or not preferred resources for the transmission by the UE.

The present invention provides a method for operating a user device, UE, for a wireless communication system wherein the UE is to transmit and/or receive over a sidelink, SL, in the wireless communication system, the SL including a SL feedback channel, like the PSFCH, for transmitting a SL feedback for a transmission over the SL using one or more first resources of the SL feedback channel associated with the transmission, the method comprising:
detecting one or more collisions on one or more resources used or reserved to be used by a further UE for one or more transmissions over the SL, and signaling a collision indication, Cl, by
transmitting a SL feedback for the transmission affected by the resource collision using one or more second resources of the SL feedback channel associated with the transmission affected by the resource collision, the first and second resources being different, or
transmitting a SL feedback for the transmission affected by the resource collision using one or more resources of a further SL feedback channel before the transmission associated with the transmission affected by the resource collision, or
transmitting a SL feedback for the transmission affected by the resource collision using one or more configured or preconfigured resources separate from the SL feedback channel, like resources of a collision indicator channel.

The present invention provides a method for operating a user device, UE, for a wireless communication system, wherein the UE is to transmit and/or receive over a sidelink, SL in the wireless communication system, the SL including a SL feedback channel, like the PSFCH, for transmitting a SL feedback for a transmission over the SL using the one or more first resources of the SL feedback channel associated with the transmission, the method comprising:
receiving from one or more further UEs a collision indication on
one or more second resources of the SL feedback channel associated with the transmission affected by the resource collision, the first and second resources being different, or
one or more resources of a further SL feedback channel before the transmission associated with the transmission affected by the resource collision, or
one or more configured or preconfigured resources separate from the SL feedback channel, like resources of a collision indicator channel.

The present invention provides a method for operating a user device, UE, for a wireless communication system, wherein the UE is to transmit and/or receive over a sidelink, SL, in the wireless communication system, the method comprising:
responsive to a request from a further UE or responsive to a certain event, transmitting to the further UE assistance information, like an assistance information message, AIM, indicating one or more preferred and/or not preferred resources for a transmission by the further UE.

The present invention provides a method for operating a user device, UE, for a wireless communication system, wherein the UE is to transmit and/or receive over a sidelink, SL, in the wireless communication system,
detecting a collision on a resource used or reserved to be used by a further UE for a transmission over the SL, dependent on one or more certain criteria, the one or more certain criteria depending on whether the UE is an intended receiver of the transmission or not and/or on whether the collision is on a resource associated with a past transmission already performed by the further UE and/or a future transmission to be performed by the further UE₁ and

responsive to detecting a resource collision, transmitting a collision indication.

Computer Program Product

Embodiments of the present invention provide a computer program product comprising instructions which, when the program is executed by a computer, causes the computer to carry out one or more methods in accordance with the present invention.

Embodiments of the present invention are now described in more detail. In the following description of embodiments of the present invention, a UE that transmits an AIM and/or a collision indication, for example in response to a request or when detecting a collision, is referred to as UE-A. UE-A may be the intended receiver of a transmission from UE-B or may be a third UE not involved in the TX-RX pair with UE-B. The transmitting or TX UE is referred to as UE-B, and UE-B is the UE that receives the AIM or the collision indication, in response to a transmission carried out or to be carried out by UE-B.

First Aspect 1—Combination of Scheme 1 and Scheme 2 to form Scheme 3

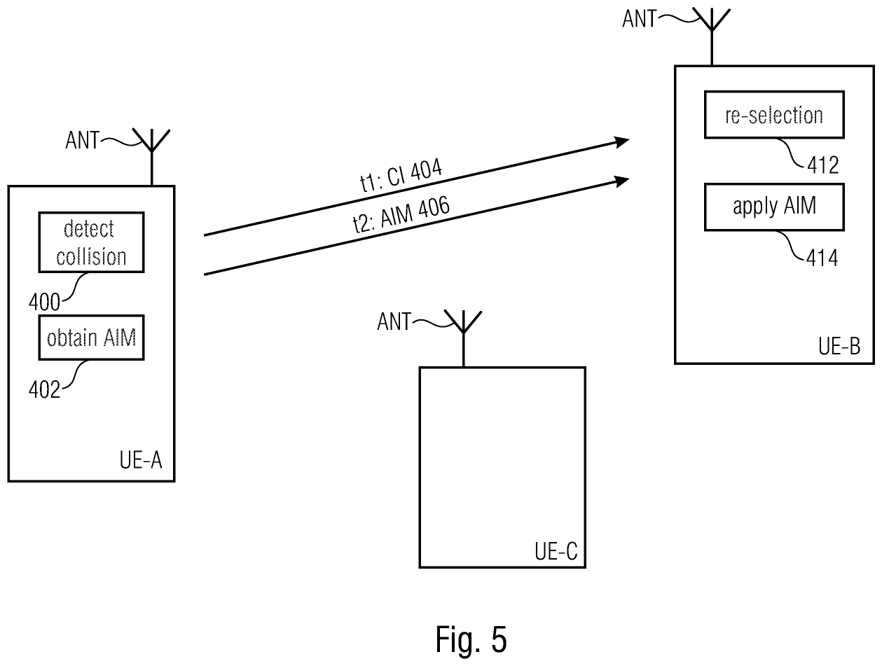

Embodiments of a first aspect of the present invention are now described in more detail. FIG. 5 illustrates an embodiment of the first aspect of the present invention. More specifically, FIG. 5 illustrates a wireless communication system in which UE-A may transmit/receive over a sidelink, SL, radio channel. For example, UE-B may send a transmission over the SL for which UE-A may be the intended recipient or not. In the latter case, the recipient may be another UE, like UE-C in FIG. 5. In either case, UE-A, as is indicated at 400, may detect a collision on resources used or reserved to be used by a transmission of UE-B. The transmission may be a transmission of a new packet that may be part of a periodic transmission, or it may a new transmission, e.g., a new transmission using not preferred resources or resources that might result in a resource collision, or it may be a retransmission of a transmission affected by the collision, e.g., a transmission not received due to the collision or canceled due to a collision detected on the associated resources. For example, the collision may occur because a transmission from UE-C on the SL radio channel is scheduled for the same resources used by UE-B. Also, the so-called half-duplex constraint may be considered a collision. In such a case, the collision is due to UE-A transmitting on the resource associated with the transmission from UE-B to UE-A. In that case, UE-A is not able to receive a reserved resource of UE-B because it is transmitting itself. Thus, when referring herein to a collision, this also covers the half duplex constraint.

In accordance with embodiment, the UE detects a collision using one or more received control messages, like SCIs, for a transmission, e.g., a 1^{st} stage SCI and/or a 2^{nd} stage SCI associated with or for a transmission performed by the UEs transmitting on the SL, like UE-B or UE-C.

Further, UE-A may obtain assistance information describing one or more preferred and/or not preferred resources on the sidelink, e.g., by performing a sensing process, as is indicated at 402. Responsive to detecting the collision at 400, UE-A transmits a collision indication, Cl, 404 and the assistance information, like an AIM 406, to UE-B. The Cl and the AIM may be sent by a common signaling or by a separate signaling. In the latter case, the signaling of the Cl and the signaling of the AIM may also include an indication or an additional signaling pointing at each other. In accordance with embodiments, the AIM may refer to resources within the same resource pool in which UE-A received the SCI.

In accordance with embodiments of the first aspect, UE-A sends the Cl 404 of a future or past collision to UE-B in accordance with the above-described conventional scheme 2, and based on this Cl 404, UE-A further sends an AIM 406 with a set of resources for UE-B to use instead of the colliding resources or a set of resources to avoid based on the future or past collision, in accordance with scheme 1. In accordance with embodiments, the Cl 404 may be a conventional feedback message, like a conventional NACK or, in accordance with further embodiments, a novel indication, different from the conventional NACK, may be employed, which is also referred to herein as a NACK-like signal, embodiments of which are described in more detail below.

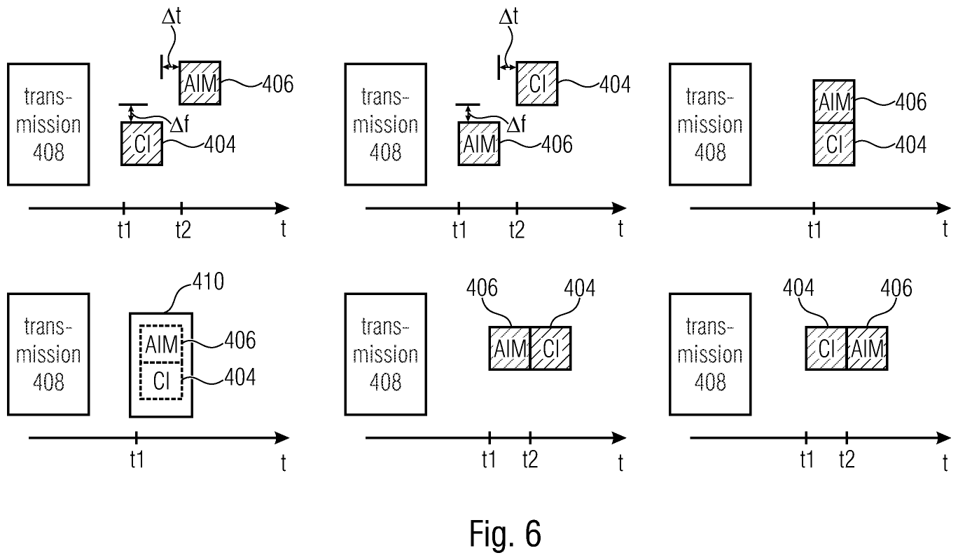

FIG. 6 illustrates embodiments of the first aspect of the present invention for transmitting the Cl 404 and the AIM 406 by the UE-A responsive to detecting a collision for transmission 408. When using a separate signaling for the Cl 404 and the AIM 406, UE-A may transmit the Cl 404 in the PSFCH or in a collision indication channel that is separate from the PSFCH, and the AIM 406 in the PSSCH or in the PSSCH or in the collision indication channel. When using a common signaling for the Cl 404 and the AIM 406, UE-A may transmit the Cl 404 and the AIM 406 in a common message, e.g., in the PSSCH or in the PSSCH or in the collision indication channel.

In accordance with the embodiment of FIG. 6(a), UE-A uses separate messages and sends the Cl 404 at a first time t1 followed by the AIM 406 at a time t2 (see also FIG. 5) with a time gap Δt therebetween on separate frequencies with a frequency gap Δf therebetween. In accordance with the embodiment of FIG. 6(b), UE-A uses separate messages and sends the AIM 406 at a first time t1 followed by the Cl 404 at a time t2 with a time gap Δt therebetween on separate frequencies with a frequency gap Δf therebetween. This is in order to cater to the processing delay that UE-B might take for processing the received AIM, and in the meantime, receives the Cl to stop UE-B from carrying out a transmission that might result in a resource collision.

In accordance with the embodiment of FIG. 6(c), UE-A uses separate messages and sends the Cl 404 and the AIM 406 at the same time t1 on continuous frequencies, i.e., at frequencies not separated by a frequency gap. In accordance with other embodiments, UE-A may send the Cl 404 and the AIM 406 at the same time t1 on separate frequencies with a frequency gap therebetween.

In accordance with the embodiment of FIG. 6(d), UE-A sends the Cl 404 and the AIM 406 at the same time t1 in a common message 410.

In accordance with the embodiment of FIG. 6(e), UE-A uses separate messages and sends the AIM 406 at a first time t1 followed by the Cl 404 at a time t2 with no time gap therebetween on the same frequencies. In accordance with the embodiment of FIG. 6(e), UE-A uses separate messages and sends the Cl 404 at a first time t1 followed by the AIM 406 at a time t2 with no time gap therebetween on the same frequencies. In accordance with other embodiments, UE-A may send the Cl 404 and the AIM 406 with a time gap therebetween.

In accordance with embodiments, the above-mentioned time gap and/or frequency gap may be configured or preconfigured, for example per resource pool or system wide or for a specific network slice, like a Ultra Reliable Low Latency Communication, URLLC, slice, or for a certain UE capability, like for a Pedestrian UE, P-UE, only, or for a certain Discontinuous Reception, DRX, pattern. The time-gap may be used for scenarios in which the UE-B is to use the resources indicated in the AIM in combination with its own full or limited sensing results 408. In such a scenario the time gap between the Cl 404 and the AIM 406 which carries a set of resources that may be used by UE-B, is introduced because if the indication triggered resource re-selection 408 at UE-B, without the time gap, there is only a limited number of resources to select from without any further information on resources that it is to avoid. Even if the UE-B generates a new candidate resource set, UE-B is not aware of resources to avoid. This is further compounded in scenarios where the congestion status of the resource pool is high so that UE-B has a high chance of selecting resources that may still cause collisions. Hence, sending the AIM with at least a set of resources for the UE-B to avoid, e.g. not preferred resources, helps UE-B in selecting non-colliding resources.

In accordance with embodiments, UE-A generates and determines the assistance information at 402, e.g., a preferred set of resources based on sensing results. For obtaining the sensing results, UE-A performs a sensing process which uses the above-mentioned parameters, and derives the parameters required by the sensing process from the received control messages, SCIs, e.g. based on or more of the following:
a priority associated with the transmission indicated in the control message,
a resource reservation period indicated in the control message,
a number of sub-channels associated with the transmission indicated in the control message e.g., a frequency resource indicator value, FRIV, format,
the resources reserved within a certain number of future time slots using, e.g., a time resource indicator value, TRIV, format,
the resource pool in which the control message was received,
one or more Hybrid Acknowledge Request, HARQ, parameters,
geo-location, e.g., a zone-ID derived from the SCI for allowing another UE which is in close vicinity to the UE to perform partial sensing or full sensing.

However, the UE-A is triggered to send the AIM due to the detection of a collision, i.e., the sending of the AIM to the UE-B is not based on a request that is sent by UE-B to UE-A for the AIM. Thus, UE-A, in such a scenario, does not have the required sensing parameters to generate a relevant candidate resource set or a specific set of resources. In accordance with further embodiments of the first aspect of the present invention, UE-A may derive the sensing parameters from received SCIs or it may use configured or preconfigured sensing parameters.

In case the Cl points to a collision that took place in the past, UE-A may have successfully decoded a first stage SCI for the failed transmission. This is true when UE-A is or is not the intended recipient for the transmission from UE-B. In case future collisions are detected, UE-A still requires to successfully decide on the first stage SCI. In accordance with embodiments, in such scenario, UE-A uses information from the received SCI, including the above-mentioned ones, to ascertain the sensing parameters. This enables UE-A to generate a set of preferred resources containing a candidate resource set, specific resources from the candidate resource set or even a set of non-preferred resources containing the worst-m resources based on the sensing results. Another parameter that is required for UE-A to carryout sensing is the remaining PDB associated with a packet being transmitted. The TRIV is indicated in the SCI, and in accordance with further embodiments of the first aspect of the present invention, UE-A estimates the remaining PDB on the basis of the TRIV and ensures that the set of preferred resources does not exceed the time slot of the last reserved resource indicated by the TRIV. For example, if the TRIV indicates time slot 5 and time slot 10 as the time slots for the next (re)transmissions, time slot 10 may be assumed to be the maximum PDB, where PDB is greater than or equal to the last reserved resource indicated in the SCI. Although the TRIV may be restricted to 32 time slots, so that it may not be a concrete indicator for the PDB, if UE-A is not aware of the actual PDB attached to a packet, restricting the resources that UE-A recommends in the preferred resource set to the last TRIV indicated resource or to 32 time slots provides for a sufficient estimate on the basis of which the UE-A may perform the sensing/selecting process. In accordance with other embodiments, also a default or configured/preconfigured PDB value may be applied by the UE-A.

In case the UE-A is the intended recipient, in accordance with embodiments, UE-A may be aware of the PDB attached to the packet being transmitted.

In accordance with further embodiments of the first aspect of the present invention, the required sensing parameters may be configured or preconfigured, for example on a resource pool level or on a system level. UE-A may use the parameters to generate a set of preferred resources along with the indication of a collision.

In accordance with yet further embodiments, the above two options of using derived sensing parameters or configured sensing parameters may be combined so that UE-A may use a default or preconfigured value for any parameter that the UE is not capable to derive from a decoded SCI.

In accordance with embodiments, the size of the AIM may be optimized, for example in case there is no initial transmission or in case there is not any configuration or pre-configuration. In such scenarios, UE-A may send the top-m resources corresponding to different priority values. For example, when assuming a set of resources {r1, r2, r3, . . . rn} and m=3, the top-m resources are {r1, r2, r3}. In accordance with further embodiments, the maximum number of resources is mapped to the highest priority, and the number m of resources that is sent decreases for lower priorities.

In accordance with further embodiments, instead of or in addition to the preferred resources, UE-A may also send a set of non-preferred resources, such as resources where future collisions may take place, for example based on past collisions or based on reserved future resources. In accordance with embodiments, the AIM may contain a specific set of resources in time and frequency or time slots where UE-A is transmitting, thereby avoiding the half-duplex issue which may be relevant when UE-A is the intended receiver for the transmission from UE-B. In accordance with other embodiments, a set of specific resources in time and frequency, or time slots may be indicated where collisions are detected for past transmission or future transmissions based on the received SCIs. This may be relevant when the UE-A is not the intended receiver but detects resource collisions between UE-B and UE-C. In accordance with further embodiments, the one or more not preferred resources are the worst-m resources, wherein the number m of resources included in the assistance information may decrease with a decrease of a priority associated with the resources.

In accordance with embodiments, providing non-preferred resources is also implemented in case UE-A successfully received the initial transmission but intends to inform UE-B about potential collision prone resources for future retransmissions.

In accordance with embodiments, UE-A may send the Cl using different cast-types, e.g., dependent on the UEs affected by the collision. For example, the Cl may be broadcast to all other UEs in reach of the UE or groupcast to a subset of other UEs in reach of the UE or a unicast to a specific UE in reach of the UE, e.g., the UE from which the UE is to expect a retransmission or one or more further transmissions.

In accordance with further embodiments of the first aspect, a UE, like UE-B in FIG. 5, is provided, which is to send a transmission or packet over the sidelink channel or simply over the sidelink either to UE-A or to UE-C. UE-B receives the Cl 404 and the AIM 406 from UE-A and, responsive to receiving the Cl 404 may start a transmission reselection process for selecting new resources for the transmission for which the Cl 404 was received. This is indicated in FIG. 5 schematically at 412. Responsive to receiving the AIM 406, UE-B may use the assistance information, like the preferred and/or not preferred resources in the AIM, for its re-selection process, as is indicated, schematically at 414. Thus, in accordance with embodiments, responsive to the collision indication, UE-B may perform at least one of the following:
sense one or more resources for a transmission over the sidelink, and select, using the assistance information, resources for the transmission from the sensed resources, so as to avoid resources associated with a collision,
use preferred resources indicated in the assistance information as resources for the transmission without performing a sensing operation,
reselect resources for a retransmission without using the assistance information,
reselect resources for a retransmission, and crosscheck with resources from the assistance information,
determine a candidate resource set or a set of resources from the candidate resource set, and combine the candidate resource set or the set of resources with one or more or all resources in the assistance information, e.g., by including or excluding resources dependent on the content of the assistance information,
not carry out sensing at all, stop any further retransmissions that were identified to cause potential collisions by the Cl, and wait for the assistance information to provide a set of resources to use, or
perform DRX, e.g., for a configured back-off,
perform a random back-off, e.g., similar to a WiFI behavior,
a handover to a base station, like a gNB,
change to another resource pool,
transmit in an exceptional pool,
switch from mode1 to mode2, or vice versa.

In accordance with further embodiments, UE-B, may decide which of the options listed above or any other know option to use dependent on a number of collisions UE-B experienced. For example, UE-B may be configured or preconfigured with one or more collision indication thresholds, and responsive to reaching a Cl threshold a certain option may be used. In accordance with embodiments, the Cl or the AIM may include an indication what option to select when the Cl threshold is reached.

Second Aspect 2—NACK-like Signal for Scheme 2 and Scheme 3

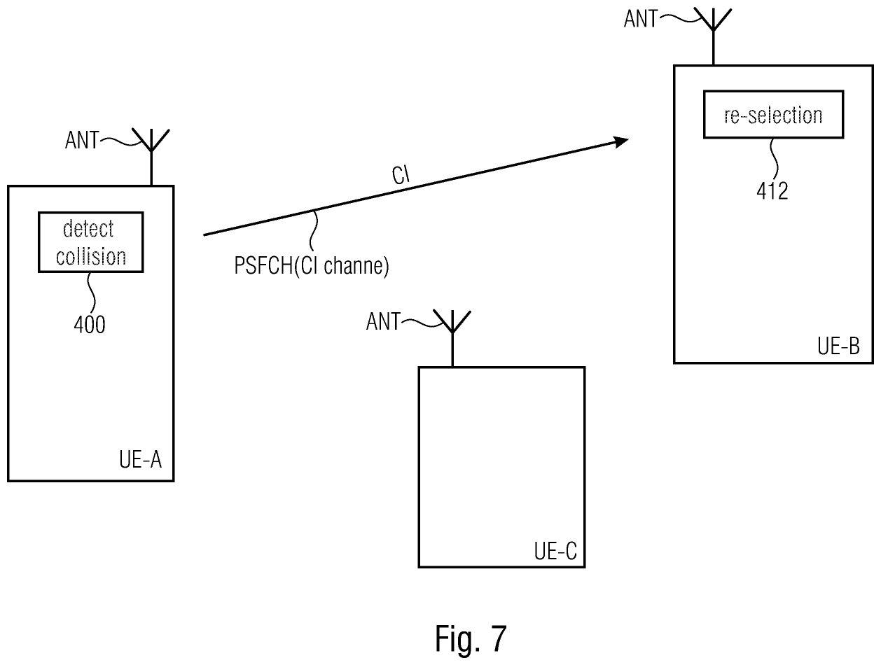

Embodiments of a second aspect of the present invention are now described in more detail. In accordance with such embodiments, a collision is indicated using a simple signal at a pre-defined resource to indicate a collision associated with a past transmission, i.e., a transmission already performed and/or a future collision, i.e., a collision associated with a transmission to be performed. FIG. 7 illustrates a wireless communication system similar to the one of FIG. 5. Again, three UEs, UE-A, UE-B and UE-C are depicted which may transmit/receive over the sidelink, SL. In accordance with embodiments, UE-A detects a collision on one or more resources used by UE-B for one or more transmissions over the SL, as is indicated at 400. Responsive to detecting such a collision, independent of whether UE-A is the recipient or not or only if it is the recipient of the transmission for which the collision was detected, UE-A, transmits a collision indication either over the sidelink feedback channel, like the PSFCH, or over configured or preconfigured resources that are separate from the SL feedback channel. Such separate resources are also referred to herein as the collision indicator channel. In FIG. 7, the PSFCH or the Cl channel are indicated schematically between UE-A and UE-B. The SL feedback channel, like the PSFCH, is provided for transmitting a SL feedback, like a NACK or a ACK, for a transmission over the SL using one or more resources of the SL feedback channel associated with the transmission.

In accordance with embodiments of the second aspect of the present invention, for signaling the collision indication, Cl, UE-A transmits a SL feedback for the transmission affected by the collision using one or more resources of the SL feedback channel that are different from the regular resources used for signaling a conventional or regular feedback associated with the transmission affected by the collision. For example, responsive to the detection of the collision, UE-A may compute an additional PSFCH resource index so as to transmit a Cl message, e.g., in the form of a ACK and/or NACK, on the additional resource. UE-B monitors the additional resource(s) of the PSFCH, and, responsive to detecting a message on the additional resource(s), determines that a collision was or is to occur on the transmission associated with the additional resource(s).

In accordance with other embodiments of the second aspect of the present invention, for signaling the collision indication, Cl, UE-A transmits the SL feedback for the transmission affected by the collision using one or more configured or preconfigured resources separate from the SL feedback channel, like resources of a collision indicator channel. These separate resources may also be used for the transmission of regular ACK and NACK instead of using the regular feedback channel for transmissions supporting the collision indication feature.

Thus, in accordance with embodiments, the collision indication may use a conventional sidelink feedback message that is transmitted on resources of the feedback channel different the resources used for transmitting the conventional sidelink feedback message. The conventional sidelink feedback message may be an acknowledgement message, ACK, or a non-acknowledgement message, NACK, that, conventionally, is used for indicating a successful/non-successful receipt of the transmission of UE-B.

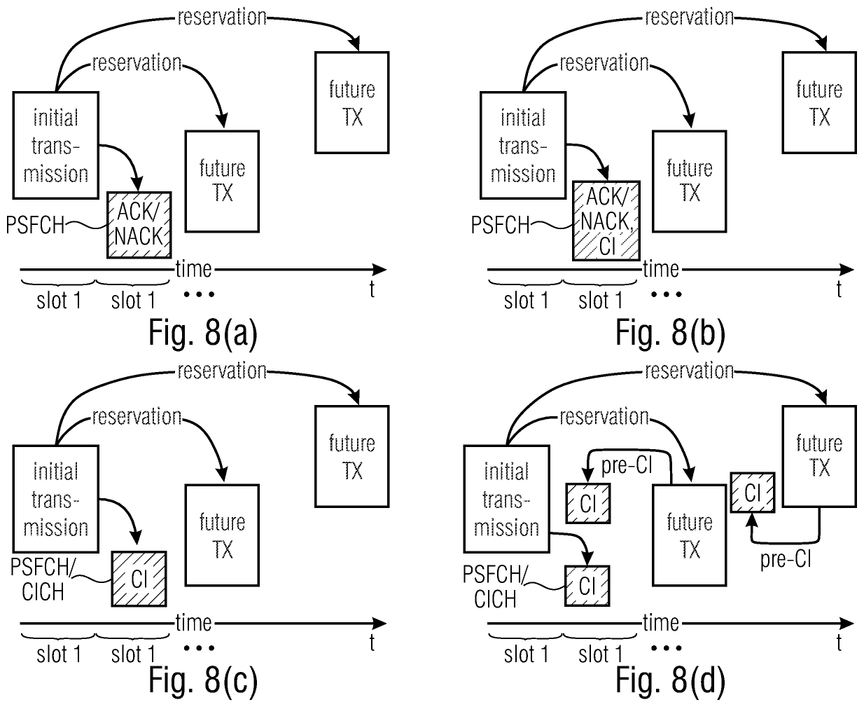

FIG. 8 illustrates further embodiments of the second aspect of the present invention. More specifically, FIG. 8(a) illustrates a conventional approach and FIG. 8(b) to FIG. 8(d) illustrate embodiments of the second aspect. In FIG. 8, it is assumed that UE-B performs an initial transmission at an initial time slot. The initial transmission also includes reservations for future transmissions of UE-B, like future transmission 1 and future transmission 2 illustrated in FIG. 8. For example, the reservation information is part of the SCI, like a 1^{st} stage and a 2^{nd} stage SCI, of the initial transmission sent by UE-B.

FIG. 8(a) illustrates the conventional ACK/NACK signaling on the PSFCH. Each transmission resource has an associated PSFCH feedback resource. In FIG. 8(a), the transmission resource for the initial transmission is in slot 1, and the PSFCH feedback resource is in slot 2. The PSFCH resource is used for transmitting an ACK or a NACK, dependent on whether the initial transmission was successfully received or not at the UE-A. The PSFCH feedback resources associated with the transition resource may be calculated by the receiver and by the transmitter, respectively. The receiver, like UE-A, indicates the feedback using the PSFCH feedback resource, and the transmitter, like UE-B, monitors the resource to receive the feedback.

The feedback may be a Hybrid Acknowledge Request, HARQ feedback. The sidelink HARQ feedback may be in the form of a conventional ACK or NACK or it may be NACK-only with nothing transmitted in case of a successful decoding. The UE transmits a Zadoff-Chu or Gold sequence in one signal resource block, PRB or sub-channel, that may be repeated over two OFDM symbols, where the first symbol may be used for automatic gain control, AGC, near the end of the sidelink resource in the slot. A NACK-only operation, conventionally, is defined for groupcast to allow a potentially lower sidelink resource demand to be created when a large number of RX UEs need to send feedback to the same TX UE. A typical use case is an extended sensor scenario where UEs within a given radius receive the same sensor information from the transmitting, TX UE₁ and retransmissions may occur if any UE fails to decode the transmitted information successfully. The one bit of sidelink HARQ feedback is carried on the PSFCH from the receiving, RX UE, to the associated TX UE. The RX UE determines the resource to be used for transmitting the PSFCH using an index according to the following formal:

(P_{ID}+M_{ID})mod R

where R is the number of PSFCH resources, P_{ID} is a source ID of the TX UE indicated, e.g., by 2^{nd} stage SCI associated with the transmission, M_{ID} is a UE-specific ID indicated by higher layers. Conventionally, M_{ID} is only used for groupcast option 2 where all receiving UEs provide individual feedback. In that case, each UE of the group has a unique M_{ID}. For unicast or groupcast option 1, M_{ID}, conventionally, is set to 0. The calculated index corresponds to a PRB or sub-channel and a cyclic shift pair of a PSFCH sequence where the NACK-sequence is rotated by 180 degree relative to the ACK-sequence.

FIG. 8(b) illustrates an embodiment of the second aspect of the present invention in accordance with which the Cl, e.g., in the form of an ACK or a NACK, is signaled on different resources of the PSFCH than the conventional feedback. For example, the ACK/NACK may be transmitted in a first subset of resources associated with the PSFCH while configured or pre-configured resources of the PSFCH separate from the ACK/NACK resources may be used for transmitting the Cl.

FIG. 8(c) illustrates a further embodiment of the second aspect of the present invention in accordance with which the Cl is transmitted on an additional or further resource. The additional or further resource(s) is separate from the PSFCH and may be referred to as a collision indicator channel, CICH. In the embodiment of FIG. 8(c), the two channels are separated in the frequency domain, however, they may also be separated in the time domain or both in the time and frequency domain. In accordance with yet other embodiments, the separate resources may be in the same channel, like in the PSFCH.

FIG. 8(d) illustrates yet a further embodiment of the second aspect of the present invention in accordance with which separate resources may be used for signaling a past collision in the initial transmission or a future collision in one or more of the reserved transmissions. For example, a collision indicator may be indicated for the initial transmission and for the first future transmission and for the second future transmission, which is also referred to as a pre-CI. In accordance with embodiments, the signaling of the past collision or the future collision may be in accordance with the signaling described with reference to FIG. 8(b) or with reference to FIG. 8(c).

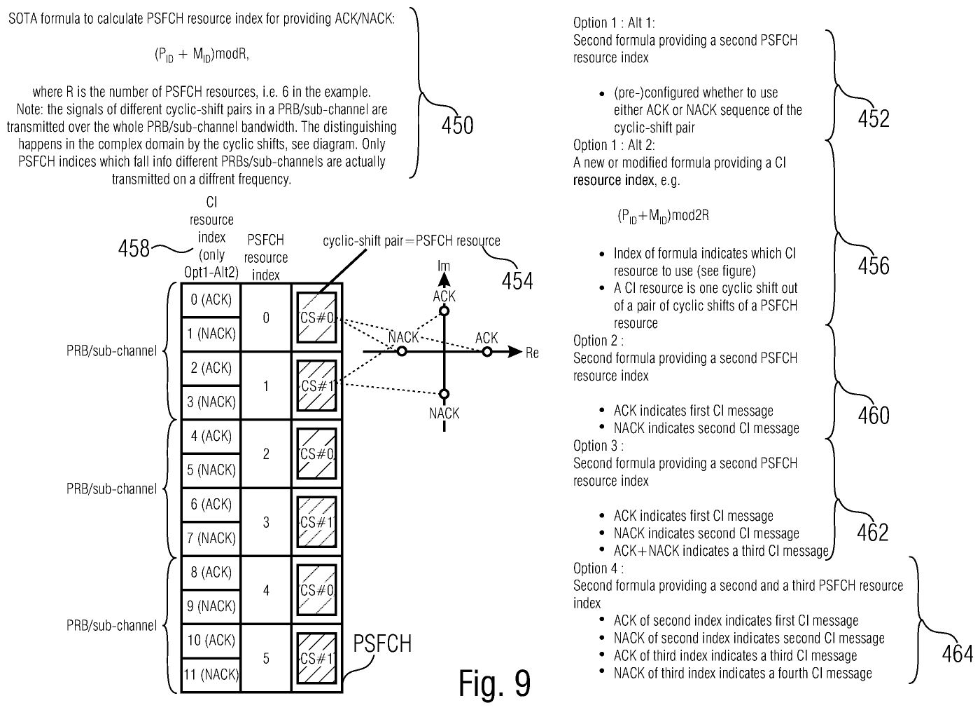

FIG. 9 illustrates embodiments of the second aspect of the present invention for signaling one or more Cl messages using the PSFCH or the Cl channel. As is illustrated at 450, in accordance with embodiments, the resource(s) for the Cl on the PSFCH or the Cl channel are obtained by calculating the PSFCH resource index for providing ACK/NACK using the above-mentioned formula:

(P_{ID}+M_{ID})mod R. (1)

R is the number PSFCH channel resources, P_{ID} is the source ID of UE-B indicated, e.g., by 2^{nd} stage SCI associated with the transmission. In accordance with embodiments, M_{ID} has a value different from the value used for signaling a conventional SL feedback, e.g., M_{ID} is set to a preconfigured or configured value or to a value that is signaled, e.g., in the 2^{nd} stage SCI, or is a destination ID for P_{ID}. In accordance with other embodiments, the following formula (2) may be used for calculating the PSFCH resource index:

(P_{ID}+C_{ID})mod R. (2)

R is the number PSFCH channel resources, P_{ID} is the source ID of UE-B indicated, e.g., by 2^{nd} stage SCI associated with the transmission. C_{ID} is a preconfigured or configured value or is a value signaled, e.g., in the 2^{nd} stage SCI, or is a value signaled by higher layers. In accordance with yet other embodiments, formula (1) and (2) may be combined as follows:

(P_{ID}+C_{ID}+M_{ID})mod R. (3)

In accordance with embodiments, as is indicated at 452, a further or second PSFCH resource index (in addition to or instead of the first PSFCH resource index that may be used for indicating resources for signaling the conventional feedback) may be provided using formula (1) or (2) or (3). On the resource(s) indicated by the index a single collision indication, Cl, message may be signaled. For example the ACK or the NACK sequence of the cyclic-shift pair may be used, as is indicated at 454. Which sequence is used may be configured or preconfigured or dynamically determined, e.g. based on an index value or based on information signaled in the SCI, at UE-A.

In accordance with embodiments, as is indicated at 456, the further or second PSFCH resource index (in addition to or instead of the first PSFCH resource index that may be used for indicating resources for signaling the conventional feedback) may be provided using formula (1) that is modified as follows:

(P_{ID}+M_{ID})mod 2R (4)

This allows splitting the cyclic-shift pair into two sequences such that not pairs but single sequences are counted when determining the position to which the calculated index is associated with. In other words, a Cl resource is one cyclic shift out of a pair of cyclic shifts of a PSFCH resource, and the index determined by the formula indicates which Cl resource 458 to use.

In accordance with embodiments, as is indicated at 460, a further or second PSFCH resource index (in addition to or instead of the first PSFCH resource index that may be used for indicating resources for signaling the conventional feedback) may be provided using formula (1) or (2) or (3). On the resource(s) indicated by the index a two or three Cl messages or states may be signaled. For example, as is indicated at 460, the ACK sequence may be signaled for indicating a first Cl message, or the NACK sequence of the cyclic-shift pair may be signaled for indicating a second Cl message. In accordance with a further example, as is indicated at 462, the ACK sequence may be signaled for indicating a first Cl message, or the NACK sequence of the cyclic-shift pair may be signaled for indicating a second Cl message, or the ACK sequence and the NACK sequence may be signaled for indicating a third Cl message.

In accordance with further embodiments, as is indicated at 464, more than one further or second PSFCH resource index (in addition to or instead of the first PSFCH resource index that may be used for indicating resources for signaling the conventional feedback) may be provided using formula (1) or (2) or (3). On the resources indicated by the index four Cl messages or states may be signaled. For example, the ACK sequence may be signaled using a resource indicated by the second PSFCH index for indicating a first Cl message, the NACK sequence may be signaled using a resource indicated by the second PSFCH index for indicating a second Cl message, the ACK sequence may be signaled using a resource indicated by the third PSFCH index for indicating a third Cl message, and the NACK sequence may be signaled using a resource indicated by the third PSFCH index for indicating a fourth Cl message. Stated more general, for signaling the collision, UE-A may transmit a SL feedback for the transmission affected by the collision using n additional resources of the SL feedback channel, n>1, and the SL feedback may include n Cl messages, each Cl message being represented by transmitting the first SL feedback message, like an acknowledgement, ACK, or by transmitting the second SL feedback message, like a non-acknowledgement, NACK, on the n^{th} resource.

In accordance with further embodiments, resources separate from the PSFCH may be employed for signaling a Cl message. For example, the resource index of a Cl channel may be calculated using formula (1) or (2) or (3), where R is the number Cl channel resources. For signaling the collision, UE-A is to transmit a SL feedback for the transmission affected by the collision using k cyclic shifts on the determined resource of the collision indication channel, k>1. The SL feedback includes
for k=1, a single collision indication, Cl, message by transmitting a first signal on the collision indication channel resource, or
for k>1, k Cl messages, each Cl message being represented by a cyclic shifted signal on the collision indication channel resource, wherein the cyclic shifts are different for the k Cl messages.
Each message corresponds to a certain cyclic shift relative to each other, e.g. first message 0°, second message 1*360°/k, . . . k-th message (k−1)*360°/k.

The above-mentioned Cl message(s) may indicate one or a combination of the following:
an ACK,
a NACK,
any collision,
a past collision
a future collision
a certain location of a collision
that in addition to the Cl also assistance information, like an AIM, is transmitted, e.g., in accordance with embodiments of the above described first aspect of the present invention.

In accordance with embodiments, the Cl may signal to UE-B one or more of the following:
The transmission associated with the resource on which the Cl is transmitted experienced a collision in the past or is to experience a collision in the future. For example, if the Cl points to a collision that occurred in the past, UE-B has to ensure that retransmissions of the collided transmission take place in re-selected resources, i.e., UE-B is to carry out a re-selection process.
A future time slot in which UE-B may expect to receive from UE-A assistance information, like an AIM, as discussed above with reference to the first aspect. In accordance with embodiments, a pre-configured or configured time gap between the time at which UE-B receives the collision indication and the time at which UE-B receives the AIM may be used, similar to the time gap between the transmission of the PSSCH and the PSFCH. The sequence may also point to a specific time slot in the future where the UE-B may expect to receive from UE-A the AIM. The sequence may also indicate a range of time slots within which the UE-B may expect to receive from UE-A the AIM. In such a case, the collision indicator may also be referred to as a wake-up or early collision-warning signal for UE-B.

As mentioned above, the Cl message(s) is sent on the PSFCH or on the Cl channel (also referred to as a PSFCH-like channel). In accordance with further embodiments, the Cl may be sent on a channel used for sending an AIM, like the PSSCH or PSSCH. UEs may monitor those time slots that carry the channel, like the PSFCH, and that are relevant for a transmission performed by the UE, for example, in accordance with a feedback configuration such as the PSFCH period and a time gap between the transmission of the PSSCH and the PSFCH. For example, when considering FIG. 8, UE-B, after having performed the initial transmission, may monitor the PSFCH resources in slot 2 for the feedback. In accordance with the inventive approach, the Cl is sent to UE-B in the above described way so as to allow UE-B to differentiate between a normal NACK, which simply triggers a retransmission using already selected resources, while the Cl may also trigger a resource re-selection. This approach is advantageous as it allows using scheme 2 or scheme 3, which have been described above with respect to the first aspect, for any cast type transmission, i.e., the conventional restriction of this approach to only groupcast option 1 is removed.

Pre-Collision Indication

In accordance with embodiments of the second aspect of the present invention as described above with reference to FIG. 8(d), the inventive Cl signaling may be used for a pre-collision indication causing the UE, which receives the pre-collision indication before it carries out the planned transmission, to perform a reselection. Embodiments of the second aspect address how the pre-collision may be convoyed by the RX UE or any other UE, like UE-A, of the system to the TX UE, like UE-B.

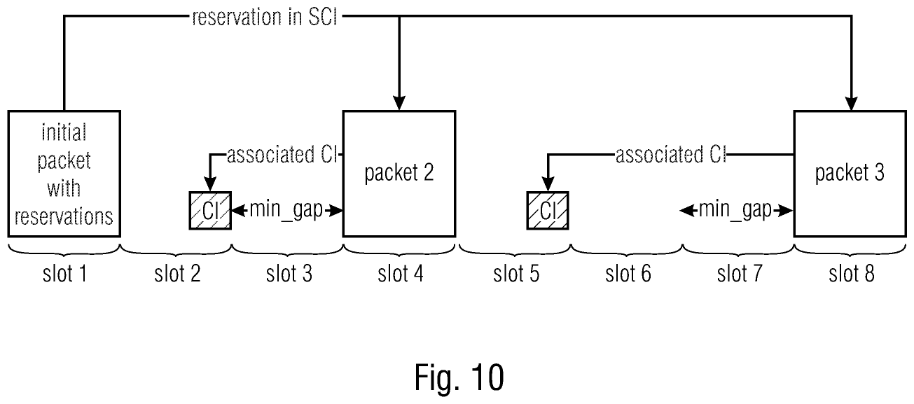

In accordance with embodiments, a minimum gap g, g≥0, is defined between the slot in which the pre-collision indication is transmitted between the associated reserved resource. This minimum gap may be preconfigured or configured by an RRC signaling or may be obtained from an SIB or an MIB. For example, the signaling may be part of the resource pool configuration. In accordance with other embodiments, the minimum gap may be indicated in a SCI associated with an initial transmission from UE-B. FIG. 10 illustrates embodiments of the present invention providing of a minimum gap for a pre-collision indication. FIG. 10 assumes a situation in which UE-B, at slot 1, performs an initial transmission so that a first packet is transmitted at slot 1. The SCI associated with the initial transmission or the initial packet also indicates reservations for future transmissions of packet 2 and packet 3 that happen at slot 4 and at slot 8. UE-A, in case of detecting a future collision in slot 4 for packet 2 and in slot 8 for packet 3, signals the collision indicator Cl ahead of the resource used for the further transmission, i.e., ahead of slot 4 and ahead of slot 8 such that the minimum time gap, min_gap, exists which, in the embodiment of FIG. 10, is at least one slot. For packet 2, the Cl is transmitted in slot 2, while for packet 3 the Cl is transmitted in slot 5.

In accordance with embodiments, the minimum gap may either indicates exactly in which slot the pre-collision indication is to be transmitted as is, for example, illustrated in FIG. 10 for the Cl associated with packet 2. In accordance with other embodiments, the minimum gap may indicate a minimum time gap such that the UE determines the latest slot containing a Cl or PSFCH channel fulfilling the minimum gap, as is illustrated with regard to the Cl associated with packet 3. For this embodiment, the UE may be configured or preconfigured with a PSFCH or Cl channel periodicity and, therefore, knows the slots which contain a PSFCH or a Cl channel. Based on this knowledge, the UE may choose the latest slot containing a PSFCH or Cl channel that is at least the distance min_gap ahead of the reserved resource.

With regard to FIG. 10 it is noted that in the depicted scenario, a representation similar to FIG. 8(c) is used in accordance with which the Cl is transmitted using a new channel or control region, however, the embodiment is equally applicable when transmitting the C in a way as explained with reference to FIG. 8(b). In other words, the Cl illustrated in FIG. 10 may either be transmitted in the conventional PSFCH or it may be signaled in the new channel or new PSFCH control region. Thus, once UE-A has determined the slot which is to contain the pre-collision indication for a certain reservation, like slot 2 or slot 5 in FIG. 10, the actual resource to be used by UE-A for signaling the pre-collision indication may be determined as described above by reusing the existing PSFCH resources or by using the new control or PSFCH region.

Inter-Working with DRX

In accordance with embodiments, UE-A may be the intended recipient for a transmission by UE-B. Further UE-A may operate in accordance with the discontinuous reception, DRX, mode for using power saving features of the SL DRX. While the TX UE, namely UE-B, is to be active so as to be able to receive the Cl, the RX UE, like UE-A, does not need to remain active once it detects a potential collision. More specifically, when operating in the DRX mode, conventionally, UE-A, being the intended recipient for a transmission from UE-B, receives an initial transmission during the DRX ON duration, during which the EU-A is active. The initial transmission from UE-B may also indicate that future transmissions are to be expected by UE-B at times outside the DRX ON duration, and responsive to such a signaling, as it may be found in the SCI associated with the initial transmission, UE-A extends its activity period by triggering an inactivity or retransmission timer in such a way that it stays active until all future transmissions from UE-B are received. However, in case it turns out that there are collisions to be expected with regard to the future transmissions, responsive to receiving the Cl, UE-B does not perform the future transmissions at the initially reserved resources but at new resources.

Therefore, in accordance with embodiments, UE-A, after sending a Cl, does not extend its active period or its DRX ON duration by triggering the inactivity timer or the retransmission timer. Rather, when UE-B sends an initial transmission with a reservation for future resources for a retransmission, and when UE-A detects a possible collision, UE-A sends a CO in the designated resource, either on the PSFCH or on the new control or PSFCH region, thereby triggering at the UE-B a resource reselection. This also means that the future resources already reserved by UE-B are no longer used or are void.

In accordance with further embodiments, a new timer is used that is triggered at the UE-A after sending the Cl so as to allow UE-A to go into the sleep node while UE-B carries out the sensing and resource reselection process. UE-A wakes up once the time elapsed which is when the retransmissions, which were originally supposed to be transmitted over the identified collision resources, are received by UE-A.

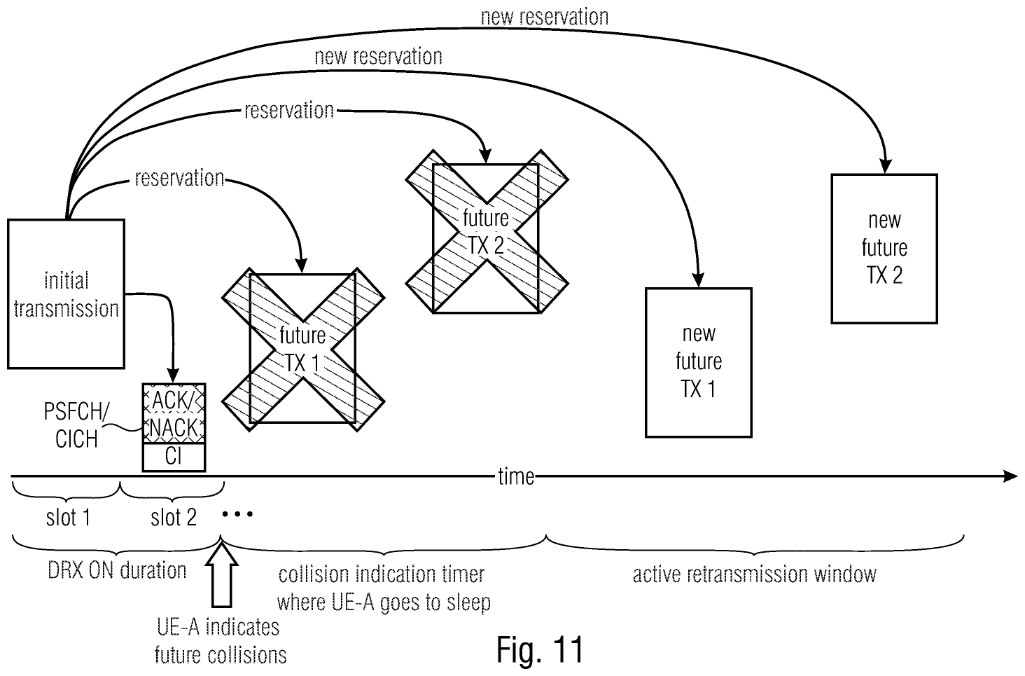

FIG. 11 illustrates an embodiment of a Cl-triggered reservation cancellation putting the RX UE into an idle mode and shifting the DRX active window for a retransmission to a time after UE-B carried out the sensing/reselection. FIG. 11 illustrates the DRX ON duration which, in the depicted embodiment, has a duration of two time slots. Δt a first time slot the initial transmission is received at UE-A from UE-B which indicates that additional transmissions, namely future transmission 1 and future transmission 2 is carried out at a time following the DRX ON duration. However, UE-A detects a collision on the resources for the future transmissions 1 and 2 and, therefore, signals in the second slot of the DRX ON duration the collision indicator Cl, for example in accordance with any one of the above described embodiments. Responsive to sending the Cl, UE-A does not extend its activity timer but triggers the collision indication timer and enters the sleep mode until the resource reselection process is completed at UE-B. Once the collision indication timer lapsed, the UE-A becomes active again, as is illustrated in FIG. 11 by the active retransmission window. Stated differently, rather than directly extending the DRX ON duration, in case of a collision, the extended ON duration is offset from the end of the DRX ON duration by the collision indication timer so as to give the EU-B the opportunity for carrying out the reselection and using the reselected resources for the future transmissions TX1 and TX2 as indicated in FIG. 11. The arrows labeled new reservation indicate the new resources determined by UE-B for carrying out the transmissions that it did not carry out (the ones marked with the big ,X”) due to the collision indicator stating that transmitting on these resources might cause collisions.

The collision indication timer mentioned above is different from the retransmission timer and it may be longer to allow UE-B to carry out the resource reselection process. The timer may be configured or preconfigured for the UE in a resource pool or system-wide manner.

In accordance with further embodiments, in case additional information is conveyed using two or more Cl messages as described above (see FIG. 9, 462, 464), UE-A may adjust its DRX cycle accordingly, for example in such a way that it goes to the discontinuous reception mode during this particular time instance. For example, in case the collision probability is above a configured or preconfigured threshold, the UE may adjust its DRX cycle accordingly so as to maximize the number of successfully transmitted data packets.

In accordance with embodiments, the collision indication may be different depending on the source UE, i.e., the UE sending the collision information. This allows the transmitting UE, like UE-B, to differentiate whether the UE, from which the Cl is received, is the RX UE, namely the intended recipient of the transmission, or is another or third UE, like UEC. In this case, when receiving the Cl indicating that the UE is the intended recipient, UE-B may assume that the inactivity or retransmission timer is extended. In case the collision indication does not indicate the source UE, UE-B does not assume that the RX UE extends its inactivity and retransmission timers as the collision indication may be signaled by a third UE, like UEC, so that assuming an extension of the inactivity/retransmission timers, in such a scenario, leads to an SL DRX misalignment between the TX UE and the RX UE.

In accordance with further embodiments, when employing scheme 3 described above with reference to the first aspect of the present invention, in accordance with which UE-A sends an AIM and the Cl, the UE-A activates the collision indication timer only after the transmission of the AIM and enters into the sleep mode after the AIM was sent. UE-A wakes up once the timer has elapsed and the retransmissions form UE-B are available.

Third Aspect—UE-A Procedure for Transmitting AIMs

In accordance with embodiments of a third aspect of the present invention, different schemes for inter-UE coordination are provided for different types of resource sets that may be contained within an AIM. In accordance with embodiments, choosing one of the above-described schemes 1, 2 or 3 may be performed in accordance with certain criteria or conditions. More specifically, in accordance with embodiments, the following schemes may be used for the inter-UE coordination, namely scheme 1 for sending an AIM including a set of resources, scheme 2 for sending an indication of a past collision or a possible future collision, and scheme 3 for sending an indication of a past collision or a possible future collision together with an AIM which, essentially, is a combination of schemes 1 and 2.

In accordance with embodiments, the AIMs to be used for the inter-UE coordination may include one or more of the following:
an indication of a past collision and/or an indication of a future collision,
a preferred set of resources, like a candidate resource set and/or a set of specific resources based on the candidate resource set that UE-B may use for its own transmissions,
a not preferred set of resources, like a set of specific resources in time and frequency or time slots when UE-A is transmitting, thereby avoiding the half-duplex issue which may be relevant when UE-A is the intended receiver for the transmission from UE-B, or a set of specific resources in time and frequency or time slots where collisions are detected in the past or in the future based on received SCIs, which may be relevant when UE-A is not the intended receiver but detects resource collisions between UE-A and UE-C(see FIG. 5 and FIG. 7)), or the worst-m resources based on the candidate resource set, or UE-A's sensing results, where the number m of resources included in the assistance information may decrease with a decrease of a priority associated with the resources.
Scheme 1

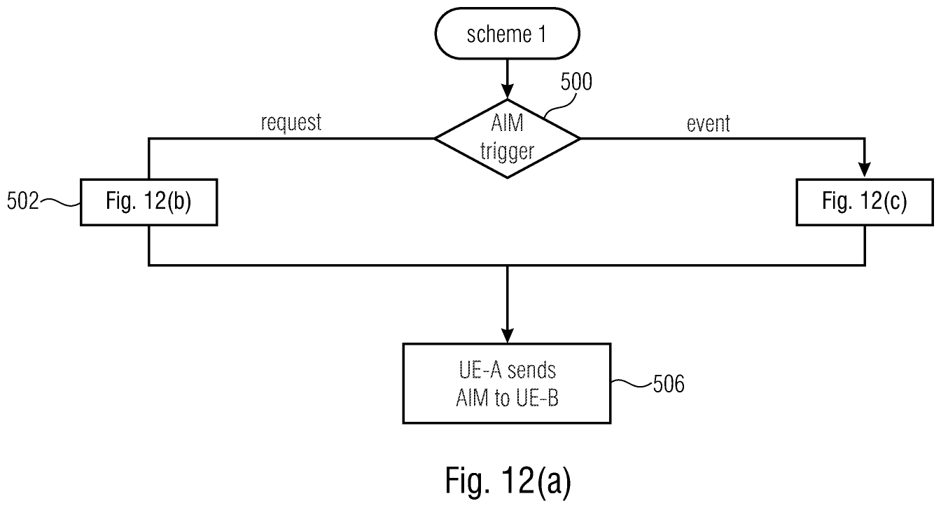

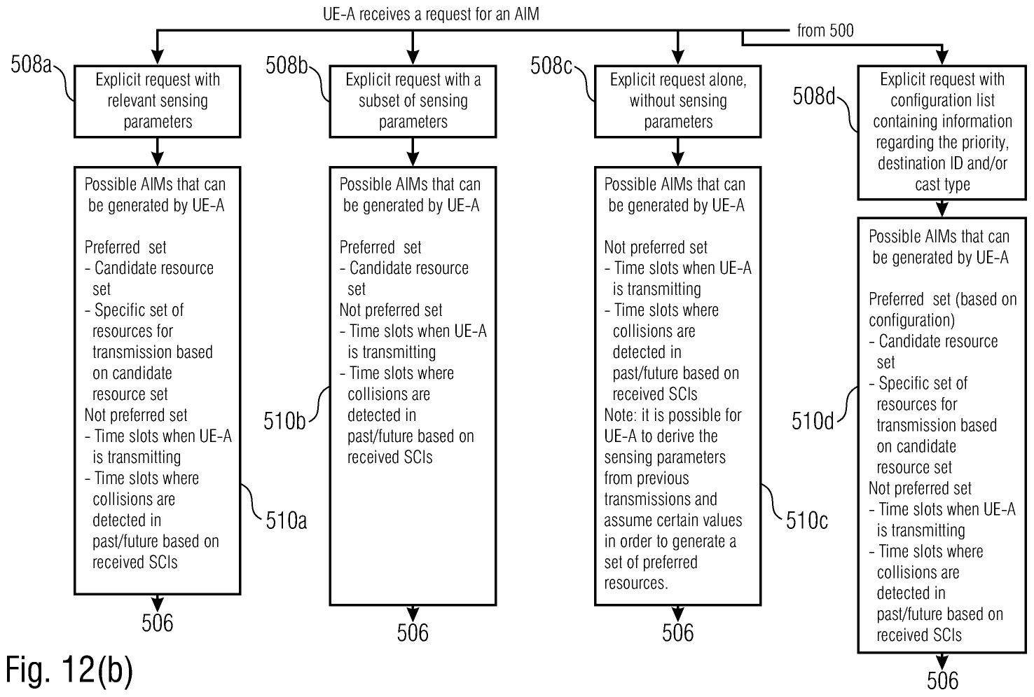

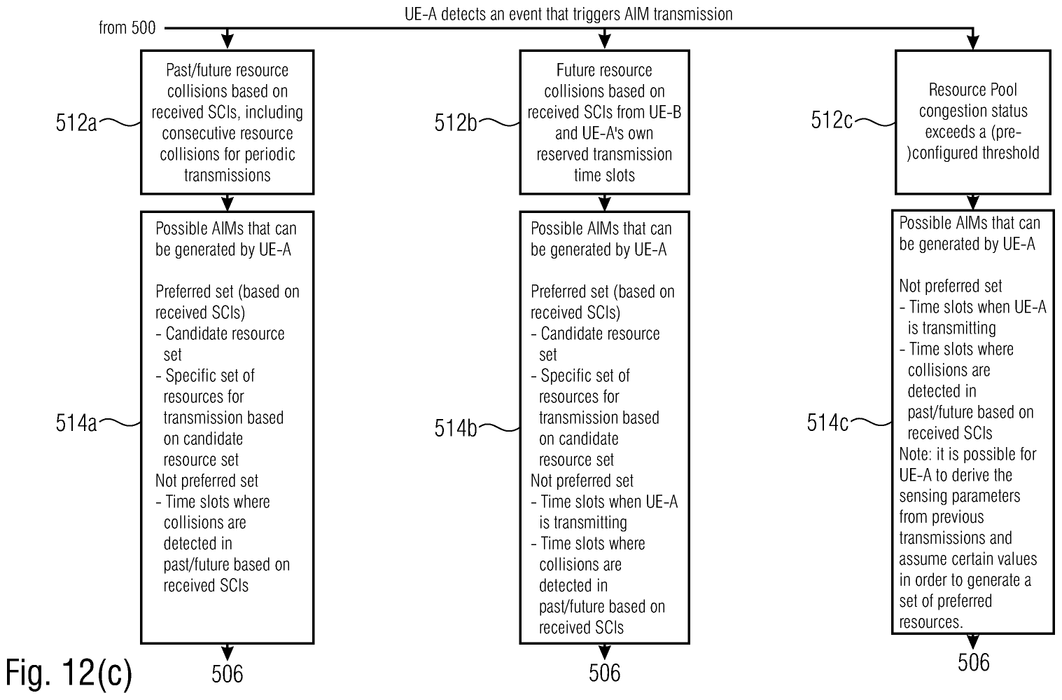

In accordance with embodiments employing scheme 1, to identify which type of AIM is to be transmitted by UE-A to UE-B, the content of the AIM and the set of resources may be decided based on the trigger mechanism used in scheme 1, which may be an explicit trigger or an implicit trigger. FIG. 12 illustrates an embodiment of a flow chart for UE-A to decide on what type of AIM to send to UE-B, when implementing scheme 1, as is illustrated in FIG. 12(a), initially, as is indicated at 500, it is decided whether the AIM trigger is an explicit trigger or an implicit trigger. The explicit trigger may be a request for an AIM that is received by UE-A from UE-B. An implicit trigger may be determined in case the UE-A detects a certain event that triggers an AIM transmission. When it is determined at 500 in FIG. 12(a) that an explicit trigger is present the method proceeds to block 502 which is described in more detail with reference to FIG. 12(b), and in case an implicit trigger is decided at 500 the method proceeds to block 504 which is described in more detail with reference to FIG. 12(c). In blocks 502 and 504, the contents of the AIM to be transmitted is decided and, once decided, UE-A sends the selected AIM to UE-B, as is indicated at 506.

FIG. 12(b) illustrates an embodiment for selecting the contents of an AIM responsive to determining at 500 that the trigger is an explicit trigger, like a request received by UE-A from UE-B. The contents of the AIM to be generated by UE-A further depends on what information is included in the request or explicit trigger. As described earlier herein, for the UE-A to create or generate an AIM, like specific resources available for a transmission, like a preferred set of resources, some sensing parameters are required by the UE-A. Dependent on the extent of sensing parameters included in the request, FIG. 12(b) illustrates the possible AIMs that may be generated by UE-A. In accordance with embodiments, the request may include all relevant sensing parameters that are needed by UE-A for creating a preferred set of resources, as is indicated at 508a. In such a scenario, as is indicated at 510a, UE-A may create a preferred set of resources and/or a not preferred set of resources, for example the above-mentioned candidate resource set or the specific set of resources, or the time slots where the UE-A is transmitting or detects a collision.

In accordance with further embodiments, the request received by UE-A may only include a subset of the needed sensing parameters for determining the contents of the AIM, as is indicated at 508b. Responsive to such a request, UE-A may create an AIM that includes the preferred set of resources and/or the not preferred set of resources, as is indicated at 510b. However, other than in the above case, due to the reduced set of sensing parameters, UE-A is only capable to provide the candidate resource set as set of preferred resources, however, not specific set of resources is provided. This is dependent on the sensing parameters provided by UE-B in the request it sent to UE-A. Without a specific priority or PDB associated with the intended transmission by UE-B, UE-A will be able to generate a generic candidate resource set, or multiple candidate resource sets corresponding to a range of priorities and PDBs. Due to this reason, it will not be able to generate a set of specific resources for UE-B to use directly for its own transmissions. UE-A might also be able to use configured or preconfigured default values for the sensing parameters, and would be able to generate a set of preferred resources.

In case the request received at the UE-A for providing an AIM does not include any sensing parameters, as is indicated at 508c, UE-A may generate AIMs including only a not preferred set of resources, as is indicated at 510c, like the time slots where UE-A is transmitting, and the time slots where a collision is detected. In accordance with further embodiments, in case UE-A is able to derive sensing parameters from previous transmissions and assume certain values, as described above with reference to the first aspect, UE-A may also create an AIM including a set of preferred resources.

In accordance with further embodiments, the request received at the UE-A may include a configuration list containing information regarding, for example, the priority, destination ID and/or cast type, as is indicated at 508d. For example, the request sent by UE-B contains one or more priorities, destination IDs and cast types for UE-A to generate AIMs, and a periodicity for transmitting the AIM. The advantage of such a configuration list is so that UE-B doesn't have to repeatedly request for AIMs. The request sent by UE-B may contain one or more priorities, destination IDs and cast types, for UE-A to generate AIMs, and a periodicity for transmitting the AIM. The advantage of such a configuration list is so that UE-B doesn't have to repeatedly send a request for AIMs. In such a case, UE-A may create an AIM that includes the preferred set of resources and/or the not preferred set of resources, as indicated at 510d. Thus, the resources are similar to those created at 510a, except that the preferred set of resources is generated on the basis of the configuration list received at 508d.

Following the generation of the AIM, the process returns to step 506 allowing UE-A to send the AIM to UE-B.

FIG. 12 (c) illustrates the AIMs to be created responsive to UE-A detecting an event triggering an AIM transmission. The AIMs generated depend on the events detected by UE-A. In accordance with an embodiment, as illustrated at 512a, UE-A, which may be the intended recipient of the transmission or not, may detect a past resource collision or a future resource collision or both, based on received SCIs which include consecutive resource collisions for periodic transmissions. In such a situation, as is indicated at 514a, UE-A may generate a preferred set of resources and/or a not preferred set of resources. The preferred set of resources may include the candidate resource set and the specific set of resources and may be obtained on the basis of the received SCIs or based on configured or preconfigured default values for the sensing parameters, as described previously. As to the non-preferred set of resources, in case the UE is not the intended recipient, only time slots are indicated where collisions are detected in the past or in the future based on the received SCIs.

In case UE-A is the intended recipient of the transmission by UE-B, the event detected by UE-A may be a future resource collision based on received SCIs from UE-A and based on transmission time slots reserved by UE-A, as is indicated at 512b. Responsive to such an event, UE-A determines an AIM including a preferred set of resources which are determined based on the received SCIs and/or not preferred resources, as is indicated at 514b. The preferred set of resources includes the above-described candidate resource set and/or the specific set of resources, while the not preferred set of resources includes the time slots used by UE-A for transmitting, the time slots where UE-A detected a past and/or future collision based on the received SCIs as well as the worst-m resources based on the candidate resource set or sensing results.

In accordance with other embodiments, the event detected by UE-A may be a certain resource pool congestion status, as is indicated at 512c. For example, in case the resource pool congestion status exceeds a configured or preconfigured threshold, UE-A may generate an AIM including only a not preferred set of resources, like the time slots when UE-A is transmitting and/or time slots where collisions are detected, as is indicated at 514c. In a similar way as described above with reference to block 510c, also in block 514c, in case UE-A is capable to derive sensing parameters from previous transmissions and assume certain values for the sensing parameters, it may generate a set of preferred resources. Following the generation of the AIM, the method proceeds to step 506 in which the UE-A sends the AIM to UE-B.

Scheme 2

In accordance with further embodiments of the second aspect of the present invention, UE-A indicates a detected collision in accordance with scheme 2, wherein indicating a detected collision, in accordance with embodiments, is based on whether UE-A is the intended recipient for the transmission from UE-B or not and whether the detected collision was in the past or is in the future.

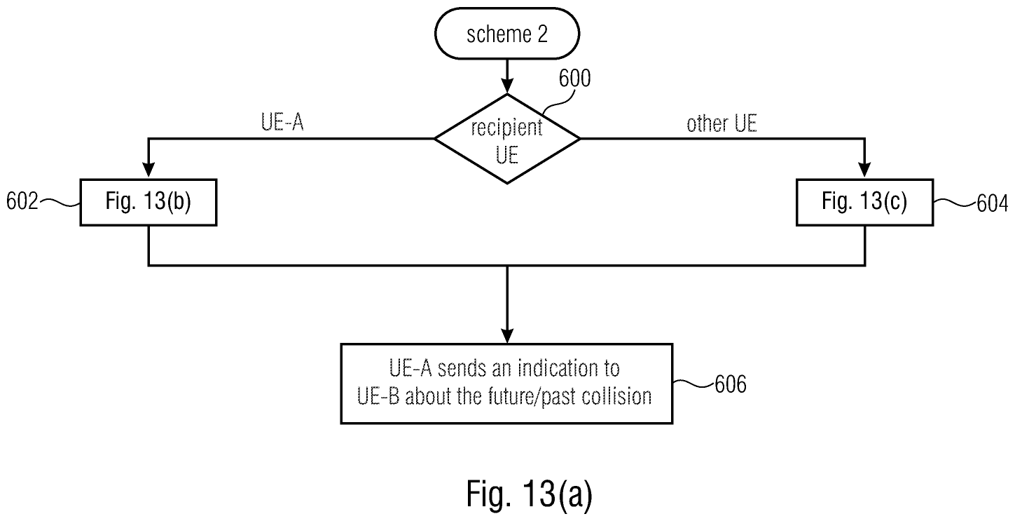

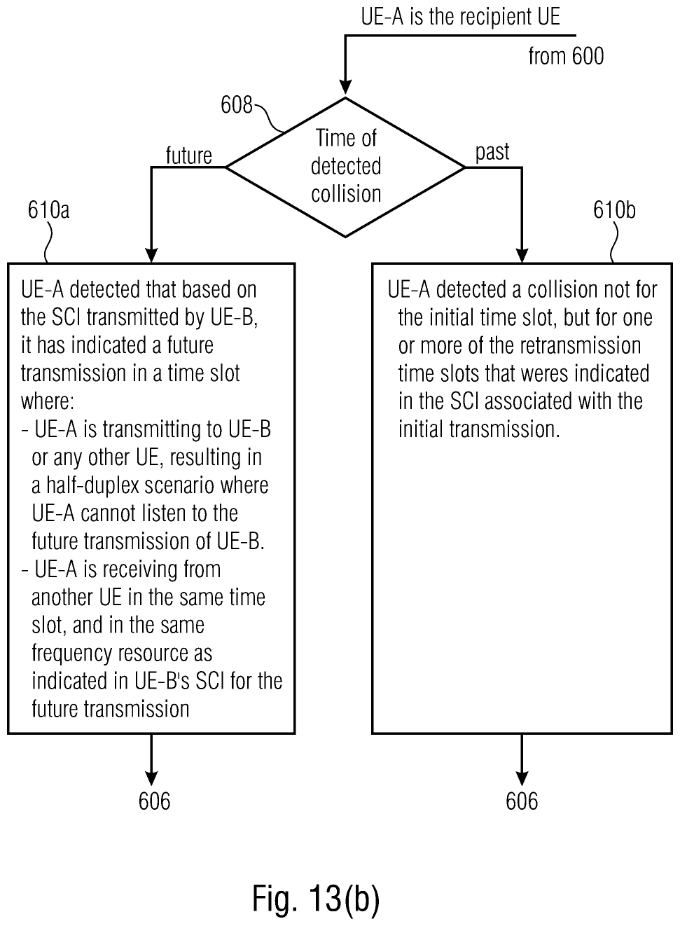

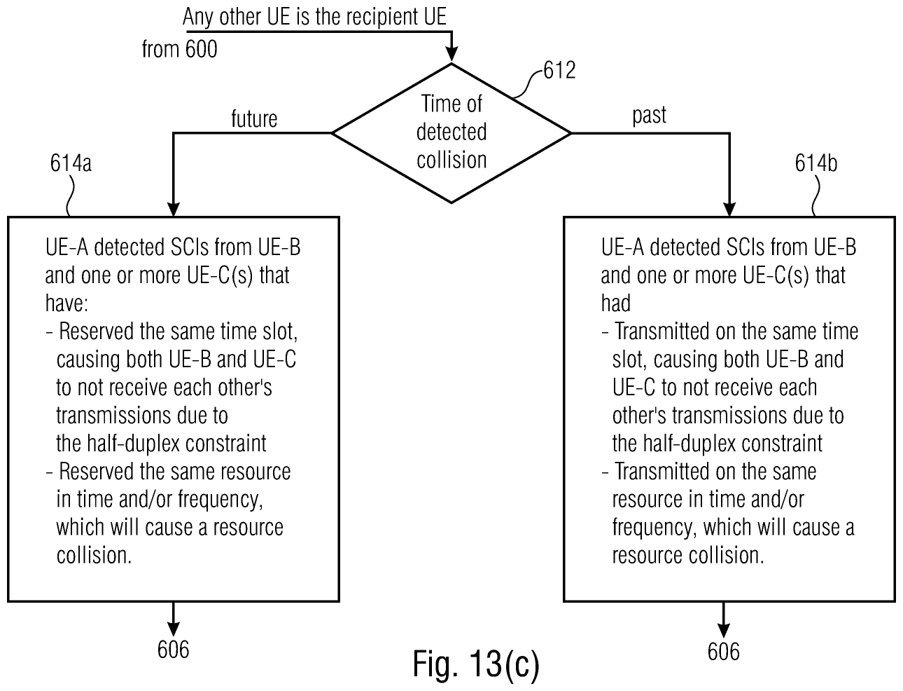

FIG. 13 illustrates a flow chart for the operation of UE-A to identify the scenario when to send a collision indication. In FIG. 13, when starting scheme 2, initially, at 600 it is determined whether UE-A is the recipient UE or not. In case that it is determined at 600 that UE-A is the recipient UE, the method goes to block 602 which is described in more detail with reference to FIG. 13(b). In case it is determined at 600 that UE-A is not the recipient UE, i.e., the any other UE in the system, like UE-C in FIG. 5 and FIG. 7, is the recipient for the transmission performed by UE-B, the method proceeds to step 604 which is described in detail with reference to FIG. 13(c). Following block 602 and 604, the method proceeds to block 606 where UE-A sends an indication to UE-B about the future and/or past detected collision.

FIG. 13(b) illustrates block 602 of FIG. 13(a) in accordance with which, responsive to detecting that UE-A is the recipient UE, it is determined at 608 whether the detected collision is a collision associated with a future transmission, i.e., a transmission to be performed by UE-B, or whether the detected collision is a past collision, i.e., a collision associated with a transmission already performed or occurred by UE-B. In case of a future collision, as is indicated at 610a, UE-A detects, based on an SCI transmitted by UE-B, that it has indicated a future transmission in a time slot where UE-A is transmitting to UE-B or to another UE or where UE-A is receiving from another UE in the same resource, across time and frequency. In case of a past transmission, as is indicated at 610b, UE-A detected a collision not for the initial time slot but for one or more of the retransmission time slots indicated in the SCI associated with the initial transmission.

Following block 610a or 610b, the method returns to block 606 where UE-A sends the indication to UE-B about the future or past detected collision.

FIG. 13(c) illustrates the scenario when the recipient UE is not the UE-A but another UE, like UE-C in FIG. 5 or in FIG. 7. Again, at 612, it is determined whether a detected collision is in the future or is in the past. In case of a future collision, as is indicated at 614a, UE-A detects SCIs from UE-B and from one or more further UEs, like UE-C, that have reserved the same time slot for communicating with each other, thereby causing a half-duplex constraint between UE-B and one or more further UEs, like UE-C, or for communicating with other UEs, thereby causing a collision on the resources. In case of a past collision, as is indicated at 614b, UE-A detects SCIs from UE-B and from one or more other UEs, like UE-C that transmitted on the same time slot with each other causing the half-duplex constraint, or transmitted with other UEs on the same resources in time and/or frequency causing a resource collision. Following block 614a or 614b, the method returns to block 606 and UE-A sends the indication to UE-B about the future of fast detected collision.

Scheme 3

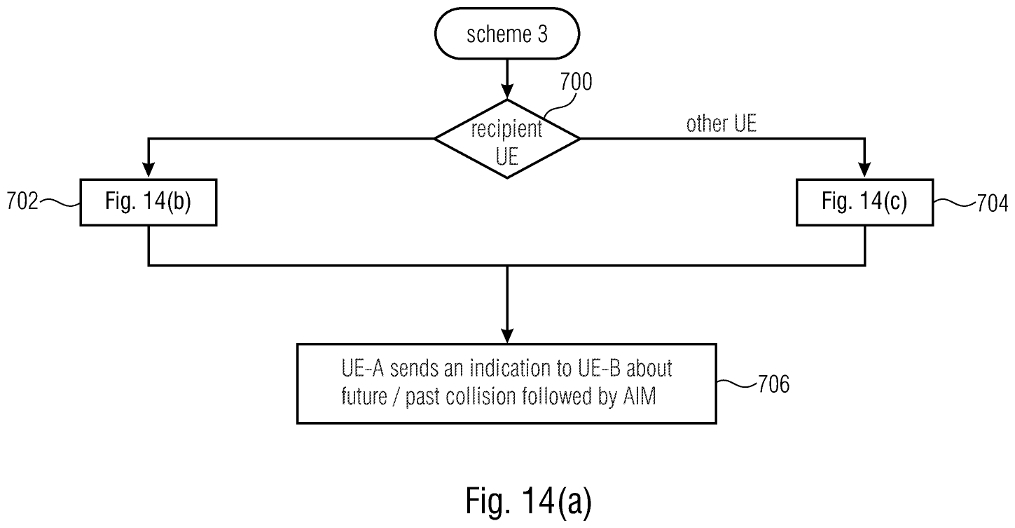

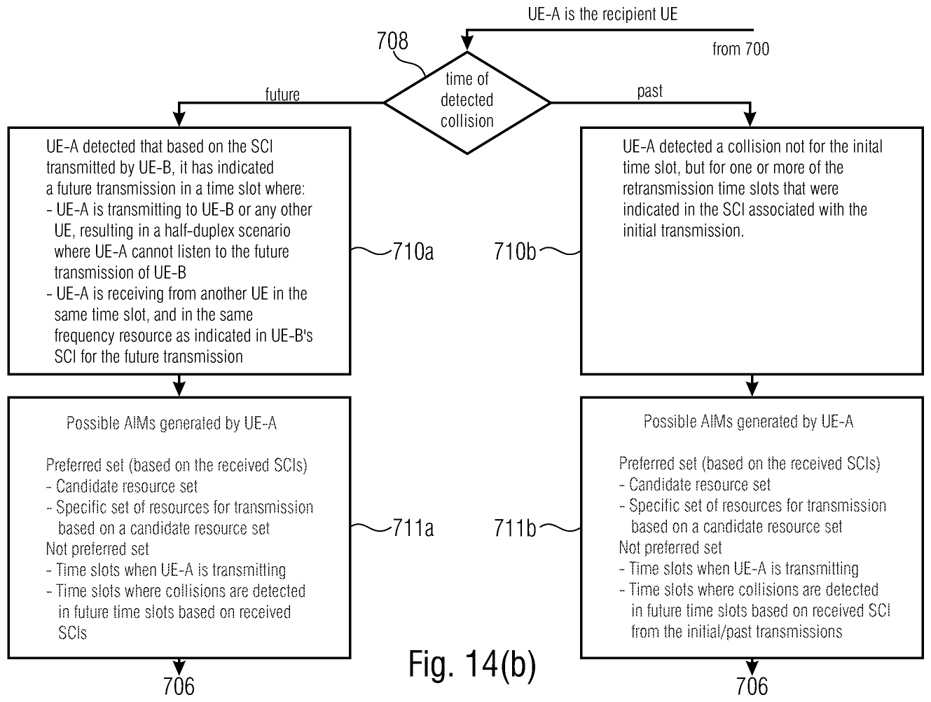

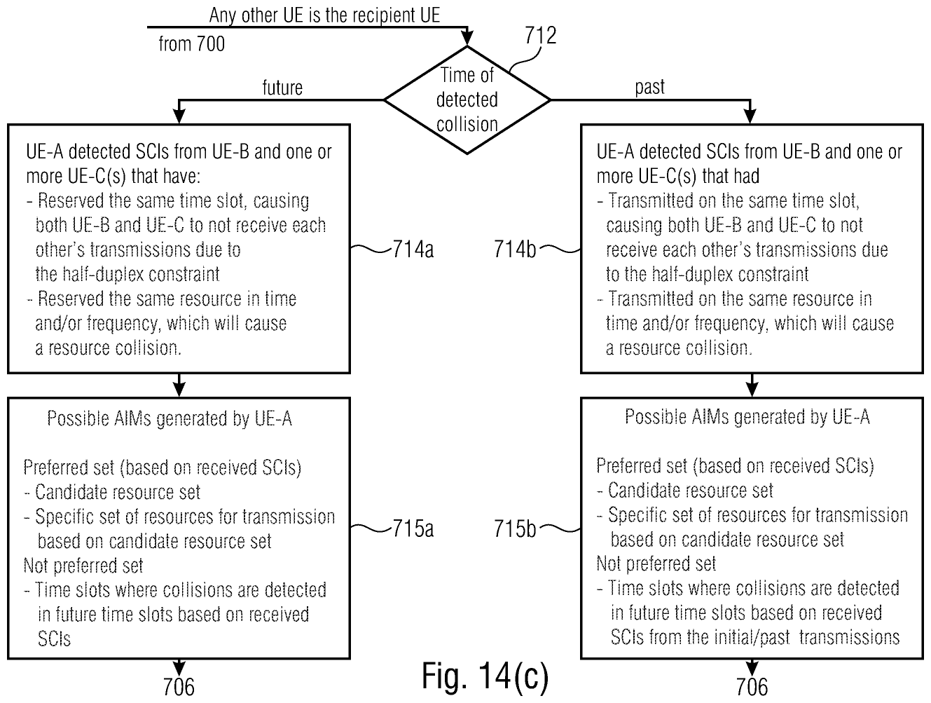

In accordance with yet further embodiments of the third aspect of the present invention, UE-A indicates a detected collision followed by an AIM dependent on the scenario that caused the collision and further dependent on whether UE-A is the intended recipient for the transmission from UE-B or not as well as whether the detected collision was in the past or is in the future and what scenario triggered the collision. The collision indication and the AIM may be transmitted in any of the possible methods described earlier, and in accordance with FIG. 6. Thus, essentially, the collision detection is performed as described above with reference to FIG. 13 and based on the detected collision, different AIM contents may be sent. The content of the resource set to be included in the AIM may include a preferred resource set, like a candidate resource set or a specific set of resources, and/or a not preferred resource set, like time slots where UE-A is transmitting or where collisions are detected by sensing or listening to transmissions of other UEs on their associated PSCCH or the worst-m resources based on the candidate resource set or sensing results generated by UE-A. FIG. 14 illustrates an embodiment of a flow chart for UE-A to identify scenarios where it sends the collision indication and the AIM, in accordance with scheme 3.

Starting scheme 3, at 700, the recipient UE is determined, more specifically whether UE-A is the recipient UE, or whether the recipient UE is any other UE, like UE-C in FIG. 5 or FIG. 7. In case UE-A is the recipient UE, the process goes to block 702 which is described in more detail with reference to FIG. 14(b), and in case the recipient UE is a different UE, the process proceeds to block 704 which is described in further detail with reference to FIG. 14(c). Following blocks 702 and 704, the process proceeds to block 706 where UE-A sends an indication to UE-B about the future and/or past detected collision which is followed by an appropriate AIM including a set of resources UE-B may employ for the reselection process.

FIG. 14(b) illustrates block 702 in further detail. In the same way as described above with reference to FIG. 13(b), initially, it is determined at 708 whether a detected collision is a future collision or a past collision. A future collision is detected in a way as described at 710a, which corresponds to block 610a described above with reference to FIG. 13(b). A past collision is detected in accordance with block 710b which corresponds to the process described above with reference to FIG. 13(b) in block 610b.

Following the detection of the collision, UE-A may generate one or more AIMs including a preferred set of resources, like the candidate resource set or the specific set of resources which are detected based on the SCIs received from UE-B. The AIM may include instead or in addition also a not preferred set of resources indicating time slots where UE-A is transmitting or time slots where collisions are detected in future time slots. In case of future collisions, collisions in future time slots are detected based on the received SCIs, as indicated at 711a, while in case of past collisions, the collisions in future time slots are detected based on a received SCI associated with an initial or a past transmission, as is indicated at 711b. Following the generation of the AIM, the process returns to block 706 where UE-A sends the collision indication and the selected AIM to UE-B.

FIG. 14(c) illustrates block 704 of FIG. 13(c) in accordance with which the recipient UE is a UE different from UE-A. At 712, like in FIG. 13(c), it is determined whether a detected collision is a future collision and a past collision. As is indicated at 714a, a future collision is detected in the same way as described above with reference to FIG. 13(c) in block 614a, while a past transmission, as is indicated as 714b, is detected in the same way as described above with reference to FIG. 13(c) in block 614b. Following the detection of a collision, UE-A generates one or more AIMs including a preferred set of resources, which are determined based on the received SCIs, for example a candidate resource set and/or a specific set of resources as mentioned above. Further, a non-preferred set of resources may also be included or may be included instead of the preferred set of resources for indicating time slots where UE-A detected a collision. In case of future transmissions, this detection is based on the received SCIs, as indicated at 715a, while in case of a past collision, these time slots are determined based on received SCIs associated with an initial transmission or a past transmission, as indicated at 715b. Following the selection of the AIMs, the process returns to step 706 where UE-A signals the detected collision and the selected AIM to UE-B.

In accordance with embodiments, UE-A may send the AIM or a collision indication or both, by using schemes 1, 2 or 3 as described above with reference to FIG. 12 to FIG. 14, based on one or more of the following criteria:
a channel busy ratio or a channel occupancy,
a type of resource collision, like a collision associated with a past transmission or a collision associated with a future transmission,
a priority of the transmission,
a time resource indicator value, TRIV,
on a destination ID,
a cast type,
a source ID,
a resource pool, RP,
resource usage within a resource pool, e.g., start sending CIs, if the number of UEs transmitting in the same band is above a (pre-)configured threshold,
a transmission type, like HARQ transmission or blind repetitions,
a channel state information, CSI,
a Reference Signal Received Power, RSRP, or a Reference Signal Received Quality, RSRQ, or a range parameter,
a bandwidth of the detected resource collision,
a network configuration,
available sensing results,
an operating mode,
a power status or power saving mode.

General

Embodiments of the present invention have been described in detail above, and the respective embodiments and aspects may be implemented individually or two or more of the embodiments or aspects may be implemented in combination.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments, the user device, UE, described herein may be one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a vehicular UE, or a vehicular group leader, GL, UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

The base station, BS, described herein may be implemented as mobile or immobile base station and may be one or more of a macro cell base station, or a small cell base station, or a central unit of a base station, or a distributed unit of a base station, or an Integrated Access and Backhaul, IAB, node, or a road side unit, or a UE, or a group leader, GL, or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

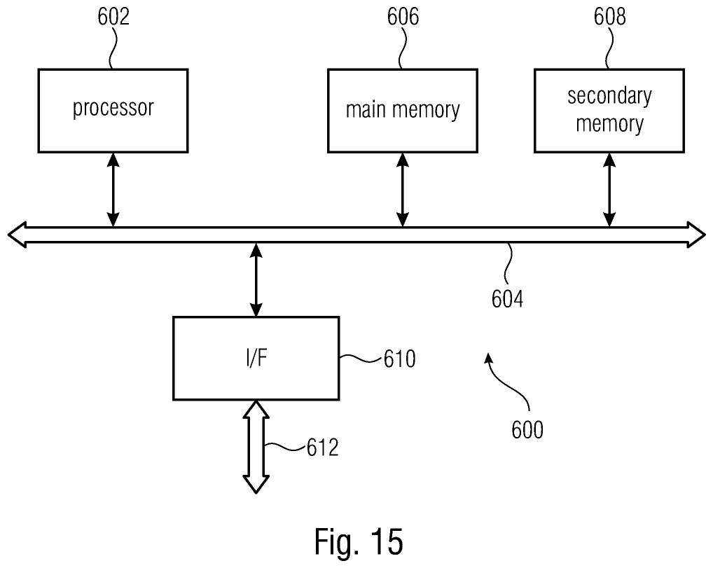

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 15 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier, or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are preferably performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A user device, UE, for a wireless communication system,
wherein the UE is to transmit and/or receive over a sidelink, SL, in the wireless communication system, the SL comprising a SL feedback channel, like the PSFCH, for transmitting a SL feedback for a transmission over the SL using one or more first resources of the SL feedback channel associated with the transmission,
wherein, responsive to detecting one or more collisions on one or more resources used or reserved to be used by a further UE for one or more transmissions over the SL, the UE is to signal a collision indication, Cl,
wherein, for signaling the Cl, the UE is to
transmit a SL feedback for the transmission affected by the resource collision using one or more second resources of the SL feedback channel associated with the transmission affected by the resource collision, the first and second resources being different, or
transmit a SL feedback for the transmission affected by the resource collision using one or more resources of a further SL feedback channel before the transmission associated with the transmission affected by the resource collision, or
transmit a SL feedback for the transmission affected by the resource collision using one or more configured or preconfigured resources separate from the SL feedback channel, like resources of a collision indicator channel.

2. The user device, UE, of claim 1, wherein, for signaling the resource collision, the UE is to transmit a SL feedback for the transmission affected by the resource collision using one second resource of the SL feedback channel, the SL feedback including
a single collision indication, Cl, message by transmitting on the second resource one of a first SL feedback message, like an acknowledgement, ACK, or a second SL feedback message, like a non-acknowledgement, NACK, or
a first Cl message by transmitting on the second resource a first SL feedback message, like an acknowledgement, ACK, or a second Cl message by transmitting on the second resource a second SL feedback message, like a non-acknowledgement, NACK, or
a first Cl message by transmitting on the second resource a first SL feedback message, like an acknowledgement, ACK, or a second Cl message by transmitting on the second resource a second SL feedback message, like a non-acknowledgement, NACK, or a third Cl message by transmitting the first and second SL feedback messages on the first and second resources.

3. The user device, UE, of claim 1, wherein, for signaling the resource collision, the UE is to transmit a SL feedback for the transmission affected by the resource collision using two second resources of the SL feedback channel, the SL feedback comprising
a first Cl message by transmitting the first SL feedback message, like an acknowledgement, ACK, or a second Cl message by transmitting the second SL feedback message, like a non-acknowledgement, NACK, on the first of the two further resources, and
a third Cl message by transmitting the first SL feedback message, like an acknowledgement, ACK, or a fourth Cl message by transmitting the second SL feedback message, like a non-acknowledgement, NACK, on the second of the two further resources.

4. The user device, UE, of claim 1, wherein, for signaling the resource collision, the UE is to transmit a SL feedback for the transmission affected by the resource collision using n second resources of the SL feedback channel, n>1, the SL feedback comprising
n Cl messages, each Cl message being represented by transmitting the first SL feedback message, like an acknowledgement, ACK, or by transmitting the second SL feedback message, like a non-acknowledgement, NACK, on the n^{th} resource.

5. The user device, UE, of claim 1, wherein, for signaling the resource collision, the UE is to transmit a SL feedback for the transmission affected by the resource collision using k messages of a collision indication channel resource, k>1, the SL feedback comprising
for k=1, a single collision indication, Cl, message by transmitting a first signal on the collision indication channel resource, or
for k>1, k Cl messages, each Cl message being represented by a cyclic shifted signal on the collision indication channel resource, wherein the cyclic shifts are different for the k Cl messages.

6. The user device of claim 1, wherein a Cl message indicates one or a combination of following messages:
an ACK,
a NACK,
any collision,
a past resource collision
a future resource collision
a certain location of a resource collision.

7. The user device of claim 1, wherein a Cl message indicates that the Cl and assistance information like an assistance information message, AIM, are transmitted, and wherein the UE is to transmit the Cl and the assistance information such that:
in the time domain,
the assistance information and the Cl are transmitted at the same time, or
the assistance information follows the Cl immediately or with a time gap therebetween, or
the Cl follows the assistance information immediately or with a time gap therebetween,
in the frequency domain,
the assistance information and the Cl are transmitted at the same frequencies, or
the assistance information and the Cl are transmitted at different continuous or separated frequencies.

8. The user device, UE, of claim 4, wherein the time gap is configured or preconfigured, for example per resource pool or system wide or for a specific network slice, like a Ultra Reliable Low Latency Communication, URLLC, slice, or for a certain UE capability, like for a Pedestrian UE, P-UE, only, or for a certain Discontinuous Reception, DRX, pattern.

9. The user device of claim 1, wherein the UE is to determine an index of the one or more second resources of the feedback channel according to
(P_{ID}+M_{ID})mod R,o
(P_{ID}+C_{ID})mod R, or
(P_{ID}+C_{ID}+M_{ID})mod R, or
(P_{ID}+M_{ID})mod 2R
where R is the number feedback or collision indication channel resources, P_{ID} is a source ID indicated, e.g., by 2^{nd} stage SCI associated with the transmission, M_{ID} has a values different from the value used for signalling a SL feedback, e.g., M_{ID} is set to a preconfigured or configured value or is signalled, e.g., in the 2^{nd} stage SCI, or is a destination ID for P_{ID}, C_{ID} is a preconfigured or configured value or is a value signaled, e.g., in the 2^{nd} stage SCI, or is a value signaled by higher layers.

10. The user device, UE, of claim 1, wherein, in case the UE detects a resource collision associated with a future transmission to be performed by the further UE, the UE is to transmit the collision indication such that there is a minimum gap between a slot in which the collision indication is transmitted and a resource associated with the collision.

11. The user device, UE, of claim 10, wherein the minimum gap indicates
in which slot the collision indication is to be transmitted, or
a minimum time gap allowing the UE to determine the latest slot comprising a PSFCH channel or a further SL feedback channel or a collision indication channel fulfilling the minimum gap, e.g., a latest slot comprising a PSFCH or a further SL feedback channel or a Cl channel at least the minimum gap ahead of the resource associated with the collision.

12. The user device, UE, of claim 10, wherein the minimum gap is
preconfigured or configured, for example by a Radio Resource Control, RRC, signaling or by a System Information Block, SIB, or by a Master Information Block, MIB, e.g., as part of a resource pool configuration, or
indicated in a SL control message, like a SCI, or
configured during the synchronization step between the two UEs.

13. The user device, UE, of claim 1, wherein
the UE is to operate in a Discontinuous Reception, DRX, mode,
the UE is the intended recipient for a transmission by the further UEs during an ON duration and one or more future transmissions after the ON duration,
responsive to transmitting the collision indication or the assistance information associated with a future transmission,
the UE is to not extend the ON duration and enter a sleep mode until the further UE completed the sensing and resource reselection process, or
the UE is to not extend the ON duration and adapt the DRX cycle such that the ON duration occurs once the further UE completed the sensing or partial sensing and resource reselection process.

14. The user device, UE, of claim 13, wherein
when entering the sleep mode, the UE is to start a collision indication timer, and, once the collision indication timer lapsed, the UE is to return to an active mode, and wherein the collision indication timer is configured or preconfigured, for example per resource pool or system wide or for a specific network slice, like a Ultra Reliable Low Latency Communication, URLLC, slice, or for a certain UE capability, like for a Pedestrian UE, P-UE, only, or for a certain Discontinuous Reception, DRX, pattern.

15. The user device, UE, of claim 13, wherein the UE is to adapt the DRX cycle in case a probability associated with the resource collision is above a preconfigured or configured threshold.

16. The user device, UE, of claim 1, wherein
in case the UE is the intended recipient for the transmission by the further UEs, the UE is to transmit a first collision indication, and
in case the UE is not the intended recipient for the transmission by the further UEs, the UE is to transmit a second collision indication, the first and second collision indications being different.

17. A user device, UE, for a wireless communication system,
wherein the UE is to transmit and/or receive over a sidelink, SL in the wireless communication system, the SL comprising a SL feedback channel, like the PSFCH, for transmitting a SL feedback for a transmission over the SL using the one or more first resources of the SL feedback channel associated with the transmission, and
wherein the UE is to receive from one or more further UEs a collision indication on
one or more second resources of the SL feedback channel associated with the transmission affected by the resource collision, the first and second resources being different, or
one or more resources of a further SL feedback channel before the transmission associated with the transmission affected by the resource collision, or
one or more configured or preconfigured resources separate from the SL feedback channel, like resources of a collision indicator channel.

18. The user device, UE, of claim 17, wherein the collision indication indicates to the further UE:
one or more resources on which the collision is to occur in the future or already occurred in the past, or
that a collision was detected, e.g., in the future or in the past, and that the UE is to expect receiving assistance information, the assistance information indicating one or more preferred and/or not preferred resources for a transmission, or
one or more resources on which the collision is to occur in the future or already occurred in the past and that the UE is to expect receiving UE assistance information, the assistance information indicating one or more preferred and/or not preferred resources for a transmission.

19. The user device, UE, of claim 18, wherein, responsive to the collision indication, the UE is to perform at least one of the following
sense one or more resources for a transmission over the sidelink, and select, using the assistance information, resources for the transmission from the sensed resources, so as to avoid resources associated with a collision,
use preferred resources indicated in the assistance information as resources for the transmission without performing a sensing operation,
reselect resources for a retransmission without using the assistance information,
reselect resources for a retransmission, and crosscheck with resources from the assistance information,
determine a candidate resource set or a set of resources from the candidate resource set, and combine the candidate resource set or the set of resources with one or more or all resources in the assistance information, e.g., by including or excluding resources dependent on the content of the assistance information,
not carry out sensing at all, stop any further retransmissions that were identified to cause potential resource collisions by the Cl, and wait for the assistance information to provide a set of resources to use, or
perform DRX, e.g., for a configured back-off,
perform a random back-off, e.g., similar to a WiFi behavior,
a handover to a base station, like a gNB,
change to another resource pool,
transmit in an exceptional pool,
switch from mode1 to mode2, or vice versa.

20. A method for operating a user device, UE, for a wireless communication system wherein the UE is to transmit and/or receive over a sidelink, SL, in the wireless communication system, the SL comprising a SL feedback channel, like the PSFCH, for transmitting a SL feedback for a transmission over the SL using one or more first resources of the SL feedback channel associated with the transmission, the method comprising:
detecting one or more collisions on one or more resources used or reserved to be used by a further UE for one or more transmissions over the SL, and
signaling a collision indication, Cl, by
transmitting a SL feedback for the transmission affected by the resource collision using one or more second resources of the SL feedback channel associated with the transmission affected by the resource collision, the first and second resources being different, or
transmitting a SL feedback for the transmission affected by the resource collision using one or more resources of a further SL feedback channel before the transmission associated with the transmission affected by the resource collision, or
transmitting a SL feedback for the transmission affected by the resource collision using one or more configured or preconfigured resources separate from the SL feedback channel, like resources of a collision indicator channel.
